(19) United States
(12) Patent Application Publication
(10) Pub. No.: US 2026/0322790 A1
(43) Pub. Date: Oct. 15, 2026

(54) Behavioral Economical Identity (BEI) Protocol for Replacing Global Switch Codes, SIM Identity, Navigation, Communication, Payment Systems, and Personal Identification

(71) Applicant: FURONG BEI, SAN GABRIEL, CA (US)

(72) Inventor: FURONG BEI, SAN GABRIEL, CA (US)

(21) Appl. No.: 19/177,628

(22) Filed: Apr. 13, 2025

(51) Int. Cl. H04L 9/40; H04L 9/32

(52) U.S. Cl. CPC H04L 63/0471; H04L 9/3218

(57) ABSTRACT

A BEI RootedDomain credential routing gateway resolves a behaviorally certified domain identity into credential state, policy state, route descriptor, and context-specific cryptographic access object. The gateway generates a TransferKey or derived TransKey for communication, payment, navigation, device access, and asset-routing contexts, applies replay-prevention, revocation, tolling, compliance, temporal trust, privacy, and risk-control rules, and records signed gateway receipts. A RootedDomain credential can operate as a unified routing pass for multiple access channels while supporting auditability, revocation, rollback, evidence-envelope export, and integration with domain routing, identity asset, sub-bank, communication, payment, navigation, device, and exchange systems.

This substitute specification describes a BEI RootedDomain credential routing gateway. The disclosure is organized to preserve the central invention as a machine-implemented gateway that receives or resolves a BEI RootedDomain credential, verifies credential and policy state, generates a TransferKey and one or more short-lived derived TransKeys, outputs a context-specific cryptographic access object, and records a signed gateway receipt with revocation, freeze, rollback, recovery, audit, and downstream interface references.

The disclosure is intended to operate with upstream identity-asset, Genesis-terminal, domain-routing, deterministic proof, BEISIGN evidence, intention-navigation, and sub-bank execution layers without absorbing those layers as the primary invention. The gateway is a middle technical corridor: it does not merely announce a human-sovereignty goal, and it does not execute a complete financial settlement engine. It generates verifiable access objects through a defined credential, key, policy, context, nonce, receipt, and lifecycle sequence.

A statement that a component may be compatible with another BEI, ATMS, 24HWS, BEISIGN, Genesis Router, Domain Routing, ActionLedger, BEIMINT, BEICurrency, TimeCurrency, BEIGX, sub-bank, deterministic clearing, or similar layer should be read as an interface or embodiment unless a claim expressly recites that component as required. This boundary is used to avoid unnecessary overlap and to keep the present application focused on credential-to-access-object gateway technology.

### Cross-Reference and Portfolio Boundary

In some embodiments, a BEI RootedDomain credential used by the gateway may be generated, certified, derived from, associated with, or verified against an upstream domain-tokenized identity asset layer. The upstream layer may create a domain identity asset, behavioral certification record, signed receipt, rollback reference, or ledger entry, while the present gateway uses the resulting credential as an input for access-object generation.

In some embodiments, a BEI RootedDomain credential may be associated with a BEI Identity Terminal generated by an upstream Genesis Router lifecycle infrastructure. The gateway may query or receive a terminal identifier, Global Asset ID reference, DID reference, BEI Address, Digital Doorplate reference, PolicyContainer hash, credential status, audit-chain pointer, or terminal lifecycle state before issuing a TransferKey or derived TransKey.

In some embodiments, the gateway may receive a route descriptor, namespace resolution result, deterministic proof reference, canonicalization profile identifier, or proof-set reference from a domain-anchored routing or deterministic clearing layer. The gateway need not execute settlement or ledger clearing. It may use such evidence to bind the TransferKey payload and signed gateway receipt to an independently verifiable route state.

In some embodiments, a TransferKey, derived TransKey, access object, or signed gateway receipt may be signed, enveloped, exported, attested, or verified using BEISIGN-compatible evidence mechanisms, including a secure-enclave primary signature, risk-triggered guardian signature, evidence envelope, TimeTape-compatible audit snapshot, printable verification reference, SIP/WebRTC header reference, ISO 20022 SupplementaryData reference, IoT attestation reference, or zero-knowledge validation hook.

In some embodiments, the requested access context may be generated by an upstream intention navigation layer that converts a request event into an intention vector. The intention vector may include an intent class, demand category, urgency value, confidence value, time window, service class, endpoint class, policy scope, privacy flag, and domain-routing preference. The gateway may use this vector to select the access-object template to be generated.

In some embodiments, a payment authorization object or asset gate object generated by the gateway may be transmitted to a downstream wallet, payment network, sub-bank computing system, domain-to-contract mapping system, deterministic clearing kernel, cross-ledger gateway, exchange endpoint, compliance endpoint, or settlement endpoint. The gateway generates authorization, route, evidence, and receipt objects; downstream systems may perform financial execution, risk enforcement, compliance, ledger settlement, currency issuance, or collateral processing when separately implemented.

### TECHNICAL FIELD

The invention relates to computer-network security, domain-linked identity, credential routing, cryptographic authorization, replay prevention, signed receipts, machine-readable access objects, multi-context gateway operation, endpoint activation, revocation and rollback state management, and integration with communication, payment, navigation, device-access, digital-asset, wallet, AI-agent, Internet-of-Things, and settlement systems.

More particularly, the invention concerns a BEI RootedDomain credential routing gateway in which a behaviorally certified or otherwise verified domain identity is resolved into credential state, policy state, route descriptor, terminal state, context state, and evidence state, and is converted into a TransferKey, one or more derived TransKeys, and a context-specific cryptographic access object.

The technical field includes identity and access management, decentralized identifiers, domain name systems, private namespaces, registry systems, wallet authorization, API gateways, zero-trust access, secure messaging, signaling protocols, payment authorization, edge-device attestation, route selection, risk-scored policy engines, append-only evidence records, Merkle-compatible receipts, and local-to-global synchronization.

### BACKGROUND

Conventional identifiers are fragmented. A telephone number, SIM identifier, device identifier, e-mail address, wallet address, username, card number, bank routing code, platform account, GPS coordinate, QR code, or government identifier typically controls a narrow domain of use and cannot by itself serve as a unified identity root for communication, payment, navigation, device access, and asset routing.

A user may be authenticated in one system and untrusted in another. A wallet may know a key but not a communication session. A communication platform may know a handle but not a payment endpoint. A device-management service may know a serial number but not a behavioral credential or policy state. A navigation service may know a coordinate but not permission, trust, or intent. This fragmentation causes repeated onboarding, weak recovery, poor auditability, and high fraud exposure.

Existing DID and verifiable credential systems provide useful identity primitives, but they do not necessarily generate machine-executable access objects for multiple contexts through one gateway. Existing API gateways and OAuth-style token systems can issue bearer tokens or short-lived credentials, but they do not bind a rooted domain identity, behavioral proof, terminal state, intention vector, route descriptor, replay-prevention state, revocation state, signed receipt, and downstream interface into one controlled path.

Existing payment authorization systems can bind payer, merchant, amount, and time information, but they typically rely on accounts, card rails, wallet providers, bank identifiers, or switch codes as primary routing roots. They do not provide a domain credential routing gateway that can generate a payment authorization object while also supporting communication, navigation, device, and asset access using the same RootedDomain credential and receipt model.

Existing SIM, eSIM, device-attestation, and mobile-network systems can authenticate devices or subscriptions, but they do not replace the primary identity root with a BEI RootedDomain credential that can generate session-specific communication or device-access objects while maintaining a signed receipt and revocation path. Device access remains tied to carrier, manufacturer, operating system, or enterprise silos.

Existing navigation systems are centered on maps, coordinates, and routes. They can be valuable subordinate services, but many interactions require a navigation-intent proof rather than a physical coordinate. A care request, payment need, legal instruction, device command, logistics exception, sensor alert, medical escalation, or AI-agent action may require intent, permission, trust, and credential routing before a geographic path becomes relevant.

Existing ledgers and audit logs can record transactions after they occur, but they do not necessarily create an issuance-time gateway receipt that binds credential state, policy state, route descriptor, nonce, time window, access-object identifier, revocation reference, decision code, and proof reference. A receipt that is not tied to the actual authorization path is less useful for dispute handling, rollback, recovery, or third-party verification.

A need exists for a specific, non-conventional technical architecture that transforms a BEI RootedDomain credential into context-specific cryptographic access objects while preserving replay prevention, policy gating, signed evidence, privacy-limited disclosure, revocation, freeze, rollback, and interface compatibility with upstream identity layers and downstream execution systems.

### SUMMARY

The invention provides a BEI RootedDomain credential routing gateway. The gateway receives an access request associated with a RootedDomain identifier, resolves the identifier into credential state, policy state, terminal state, route descriptor, and optional intention state, verifies behavioral, device, identity, or policy proofs, and generates a TransferKey bound to a canonical payload. One or more short-lived derived TransKeys may be derived for a selected access context.

The selected access context may include a communication context, payment or remittance context, navigation context, device-access context, AI-agent or robot context, wallet context, IoT command context, asset-routing context, emergency context, or registry context. Each context uses a context-specific access object template so that the object fields, permission scope, endpoint reference, lifetime, receipt path, and failure behavior match the intended execution environment.

The gateway includes a replay-prevention mechanism. In one embodiment, a nonce is generated from a RootedDomain identifier, request counter, random value, context type, and policy version. The nonce is inserted into a consumed-nonce table or equivalent state store after successful issuance or use. A repeated nonce, expired time window, wrong context, mismatched endpoint, revoked credential, frozen terminal, or invalid policy state causes rejection, throttling, rerouting, freeze, rollback, or escalation.

The gateway records a signed gateway receipt. The receipt may include an access object identifier, TransferKey digest, TransKey digest, source RootedDomain reference, target endpoint reference, route descriptor digest, intention-vector hash, policy version hash, credential-state digest, terminal-state reference, nonce, time window, decision code, reason code, revocation reference, rollback reference, and signature material. The receipt may be compatible with ActionLedger, evidence-envelope, TimeTape, proof-set, BEIManifest, QR-verification, ISO 20022, SIP/WebRTC, or API-log export formats.

The gateway improves computer and network operation by replacing fragmented account, device, payment, communication, and navigation identifiers with a single credential-to-access-object conversion path. This path changes machine state by resolving credentials, selecting context, verifying policy and trust state, creating signed and bounded access objects, preventing replay, recording receipts, and updating revocation, risk, trust, recovery, or audit state.

### BRIEF DESCRIPTION OF THE DRAWINGS

FIG. 1 illustrates overall BEI RootedDomain credential routing gateway including credential input, resolver, verification, key generation, BEIGate authorization, context object generation, receipt storage, and downstream interfaces.

FIG. 2 illustrates portfolio boundary architecture showing upstream Domain Routing, Identity Asset, Genesis Terminal, BEISIGN evidence, Intention Navigation, the present credential gateway, and downstream Sub-Bank or execution layers.

FIG. 3 illustrates BEI RootedDomain credential data structure including domain reference, credential identifier, terminal reference, behavioral proof reference, policy state, validity window, revocation reference, and signature.

FIG. 4 illustrates RootedDomain resolver generating credential state, policy state, route descriptor, terminal state, intention state, and proof-set reference.

FIG. 5 illustrates TransferKey and derived TransKey data structures including canonical payload, nonce, time window, context type, permission scope, route descriptor digest, credential digest, and receipt pointer.

FIG. 6 illustrates BEIGate authorization and tolling flow showing policy gate, risk gate, temporal trust score, compliance pre-check, fee rule, decision code, and access-object issuance.

FIG. 7 illustrates replay-prevention time-window flow using nonce generation, consumed-nonce table, expiry check, revocation check, duplicate detection, and freeze or rollback response.

FIG. 8 illustrates communication access object generation for messaging, voice, video, WebRTC, SIP, sessionless or temporary channel, and EmotionComm-compatible intent communication.

FIG. 9 illustrates payment or remittance authorization object generation binding payer domain, recipient or merchant domain, value descriptor, time-value proof, downstream wallet or sub-bank endpoint, nonce, and receipt.

FIG. 10 illustrates navigation intent object generation using movement signal, presence proof, location confidence, route-intent data, privacy rule, and GeoNode-compatible intent path map.

FIG. 11 illustrates device, AI-agent, robot, wallet, vehicle, sensor, and IoT access object generation using device attestation, scoped permission, terminal state, and revocation control.

FIG. 12 illustrates asset gate object generation for requesting access to a digital asset, credential ledger, deterministic clearing kernel, sub-bank contract interface, exchange endpoint, or settlement endpoint.

FIG. 13 illustrates signed gateway receipt and evidence-envelope structure including receipt hash, TransferKey digest, access object identifier, policy decision, revocation state, proof reference, and signature.

FIG. 14 illustrates revocation, freeze, rollback, recovery, inheritance, and terminal-state gate flow including live, review, suspended, revoked, recovered, inherited, and expired states.

FIG. 15 illustrates API, SDK, local-global bridge, platform interoperability, and verifier endpoint integration for web services, Web3 systems, AI agents, IoT gateways, wallets, cloud services, and external rails.

FIG. 16 illustrates merchant, wallet, payment, remittance, ISO 20022, and sub-bank interface showing authorization-object delivery and downstream execution boundary.

FIG. 17 illustrates SIM-free device and communication integration showing terminal binding, secure enclave or hardware attestation, communication header references, and remote revocation.

FIG. 18 illustrates asset, exchange, BEIGX, BEICurrency, TimeCurrency, ATMS, BEIMINT, BEIIndex, deterministic proof, and settlement interface topology as non-limiting downstream or adjacent layers.

### DEFINITIONS

As used herein, BEI means Behavioral Economic Identity. In this application BEI is used as a technical identity framework and is not broadened into unrelated meanings unless expressly stated as an example. BEI may be associated with a human, institution, terminal, device, wallet, agent, robot, service endpoint, or domain-linked resource.

As used herein, BEI RootedDomain credential means a machine-readable credential anchored to a BEI domain identifier, ReadName, domain handle, domain-based terminal address, registry handle, decentralized namespace identifier, DID, BEI Address, Digital Doorplate reference, or equivalent name resource. The credential may include or reference behavioral proof, credential status, policy state, terminal state, revocation state, and signature material.

As used herein, RootedDomain resolver means a resolver that maps a BEI RootedDomain identifier to credential state, policy state, route descriptor, terminal state, endpoint reference, and optional proof-set reference. The resolver is not limited to public DNS and may include private namespace, distributed hash table, registry table, DID document, content-addressed index, endpoint directory, or deterministic route map.

As used herein, TransferKey means a cryptographic authorization object generated for a request context and bound to a BEI RootedDomain credential, canonical payload, time window, nonce, route descriptor, permission scope, revocation reference, and signed receipt reference.

As used herein, TransKey means a short-lived, context-specific key, token, session object, or access object derived from or associated with a TransferKey. A TransKey may be consumed by a communication endpoint, wallet, merchant, device, navigation service, AI-agent tool, robot controller, IoT gateway, asset endpoint, verifier, or downstream execution system.

As used herein, BEIGate means a gateway authorization module or gateway computing system that determines whether a request associated with a BEI RootedDomain credential is allowed, rejected, throttled, rerouted, frozen, escalated, or rolled back. BEIGate may apply policy, risk, trust, intention, compliance pre-check, toll, fee, revocation, terminal-state, and evidence rules.

As used herein, context-specific cryptographic access object means a machine-readable object that authorizes a defined context. The object may include object identifier, context type, source RootedDomain reference, target endpoint reference, permission scope, nonce, time-window value, route descriptor digest, credential-state digest, policy version, terminal-state reference, revocation reference, signature, and receipt pointer.

As used herein, signed gateway receipt means a cryptographically protected record of the access decision and object issuance. It may be stored in an ActionLedger, evidence envelope, proof set, TimeTape snapshot, receipt ledger, local cache, deterministic log, or verifier service.

As used herein, intention vector means a machine-readable request object that may include intent class, demand category, urgency, confidence, time window, service class, endpoint class, policy scope, privacy flag, and domain-routing preference. It may be generated by an upstream intention navigation layer or by the gateway.

As used herein, temporal trust routing score means a score, vector, rule output, graph path value, or risk indicator based on urgency, temporal validity, trust weight, permission fit, endpoint availability, service capability, response history, dispute state, privacy requirement, domain priority, and synchronization state.

As used herein, ActionLedger-compatible evidence record means a route or service evidence record that includes at least one of an intention-vector hash, selected endpoint identifier, permission basis, route score, timestamp, cryptographic verification value, ledger-state hash, TransferKey digest, TransKey digest, revocation reference, and signature.

As used herein, ReadName means a self-owned domain handle, domain-linked name, or equivalent machine-resolvable identity root used as a sovereign or user-controlled access key in some embodiments. ReadName is one example of a BEI RootedDomain credential source and is not required in every embodiment.

As used herein, EmotionComm-compatible communication means a communication embodiment in which voice input, mood state, emotional signal, intention state, behavioral-time proof, or domain credential state contributes to a temporary, session-limited, sessionless, or dynamic communication channel.

As used herein, GeoNode-compatible navigation means a navigation embodiment in which behavioral movement signals, presence proof, location confidence, route-intent data, privacy rules, or an intent path map contribute to a navigation intent object.

As used herein, Time Wallet-compatible authorization means a payment or remittance embodiment in which a value descriptor, time-derived contribution reference, rhythm proof, behavior proof, or wallet endpoint reference is bound into a payment authorization object.

As used herein, AI Guardian means a guardian module, local AI assistant, risk-triggered verifier, secure enclave, hardware security module, trusted execution environment, institutional validator, or user-approved secondary verifier that may provide secondary approval or signature under risk rules.

### Data Structures

The following data structures are non-limiting examples. Field names may vary in implementation, but the relationships among credential state, policy state, route descriptor, context type, nonce, time window, access-object identifier, revocation reference, and signed receipt should be preserved for compatibility with the claimed gateway architecture.

| Record | Representative fields | Technical purpose |
|---|---|---|
| Credential Record | rooted_domain_id; | Defines the identity root |
| | credential_id; terminal_id; | and credential state used |
| | DID_ref; BEI_address; | before a TransferKey may be |
| | behavioral proof_ref; status; | issued. |
| | policy_hash; revocation_ref, | |
| | validity_start; validity_end; | |
| | signature | |
| Route Descriptor | source_domain; | Binds the credential |
| | target_endpoint; | request to a specific route and |
| | endpoint_class; route_policy; | endpoint selection source. |
| | route_descriptor_digest; | |
| | namespace_source; | |
| | proof_set_ref; | |
| | canonical_profile_id | |
| TransferKey Package | transferkey_id; | Primary authorization |
| | source_rooted_domain; | object for the request context. |
| | context_type; | |
| | permission_scope; nonce; | |
| | time_window; | |
| | canonical_payload_hash; | |
| | route_descriptor_digest; | |
| | policy_version; | |
| | receipt_pointer; signature | |
| TransKey Package | transkey_id; | Short-lived access object |
| | transferkey_ref; endpoint_ref; | consumed by a specific |
| | session_or_transaction_scope; | endpoint or service. |
| | one_time_use_flag; | |
| | expiration; consumed_state; | |
| | signature | |
| Access Object | object_id; context_type; | Machine-executable |
| | source_domain; | context object used by |
| | target_endpoint; | communication, payment, |
| | permission_scope; nonce; | navigation, device, or asset |
| | time_window; revocation_ref; | systems. |
| | route_digest; signature; | |
| | receipt_pointer | |
| Gateway Receipt | receipt_id; | Audit record for issuance, |
| | access_object_id; | rejection, throttling, freeze, |
| | transferkey_digest; | rollback, or recovery. |
| | transkey_digest; | |
| | decision_code; reason_code; | |
| | policy_hash; risk_score; | |
| | trust_score; timestamp; | |
| | ledger_hash; signature | |
| ActionLedger Evidence | intention_hash; | Compatibility record |
| | selected_endpoint_id; | linking 628 receipt to |
| | permission_basis; | intention navigation and |
| | route_score; event_time; | terminal activation evidence. |
| | cryptographic_value; | |
| | ledger_state_hash; | |
| | dispute_flag; privacy_scope | |
| Evidence Envelope | credential_hash; | Exportable verification |
| | route_digest; | package for BEISIGN, |
| | access_object_id; nonce; | TimeTape, QR verifier, ISO |
| | time_window; revocation_ref; | 20022, or API endpoint. |
| | primary_signature; | |
| | secondary_signature; | |
| | proof_ref | |

### System Architecture

The system includes one or more processors, memory, network interfaces, secure key stores, resolver interfaces, endpoint directories, policy engines, context selectors, nonce stores, consumed-nonce tables, cryptographic signing modules, receipt stores, verifier services, local caches, and downstream connectors. The modules may be implemented centrally, distributed, local-first, mobile-first, edge-based, cloud-based, hybrid, hardware-assisted, or as an SDK embedded in another product.

A RootedDomain resolver receives a domain-linked identity input and produces a resolution descriptor. The descriptor may contain the credential state, route descriptor, endpoint reference, namespace source, policy version, terminal state, and proof-set reference. A resolution descriptor can be signed so that later modules do not rely on unverified strings or transient address lookups.

A credential verification engine verifies the credential status and any required behavioral, device, institutional, presence, wallet, or terminal proof. The verification may compare behavior-history hashes, device attestation measurements, secure enclave signatures, DID proofs, guardian confirmations, institutional records, ActionLedger entries, TimeTape snapshots, or BEIManifest references.

A context selector determines the access context. In one implementation, the selector receives an upstream intention vector from an intention-navigation layer. In another implementation, the gateway derives context from request headers, endpoint class, policy scope, route descriptor, device type, value descriptor, communication target, navigation intent, AI-agent tool call, robot command, or asset endpoint request.

A TransferKey generation module constructs a canonical payload. The payload may be serialized using a canonicalization profile that fixes field order, type normalization, string encoding, timestamp format, byte representation, null handling, and array ordering. The canonical payload is then hashed and signed, reducing ambiguity when different systems verify the same access event.

A TransKey generation module derives short-lived objects from the TransferKey. A communication TransKey may authorize a pre-session signaling step. A payment TransKey may authorize a transaction or remittance request. A navigation TransKey may authorize retrieval or submission of a route-intent proof. A device TransKey may authorize a bounded command. An asset TransKey may request access to an external asset endpoint or clearing interface.

A BEIGate authorization module applies policy and state rules. The module may accept, reject, throttle, reroute, quarantine, freeze, escalate, or roll back issuance based on credential status, terminal lifecycle state, intention vector, temporal trust score, risk score, fee rule, toll rule, privacy rule, compliance pre-check, revocation reference, nonce status, time-window status, endpoint state, and downstream interface requirement.

A route execution module outputs the access object to a target endpoint, verifier, local terminal, wallet, communication service, device gateway, navigation service, API gateway, evidence service, deterministic proof kernel, sub-bank system, exchange endpoint, or settlement connector. The output may be synchronous or asynchronous and may use a direct API response, signed message, QR reference, deep link, signaling header, structured payment field, or encrypted package.

A receipt module writes the signed gateway receipt. The receipt may be stored locally and synchronized later, inserted into an append-only ledger, exported as an evidence envelope, hashed into a proof set, referenced by a QR verifier, or attached to an ActionLedger route evidence record. A receipt can be generated for both positive and negative decisions, including non-activation, rejection, and risk escalation.

### TransferKey Canonical Payload and Generation

In one embodiment, the gateway creates a TransferKey only after the RootedDomain resolver returns a valid credential state and a route descriptor. The gateway selects a canonicalization profile and builds a payload from source_rooted_domain_id, credential_id, terminal_id, context_type, target_endpoint_id, permission_scope, nonce, time_window_start, time_window_end, policy_version_id, route_descriptor_digest, credential_state_digest, revocation_reference, intention_vector_hash when available, temporal_trust_score when available, and receipt_pointer when preallocated.

The canonical payload may be serialized by sorting fields according to the canonicalization profile, normalizing timestamps to a declared format, representing booleans and enumerations in a fixed byte form, applying declared numeric precision, omitting prohibited non-deterministic fields, and including an explicit canonical_profile_id. The gateway computes transferkey_digest=H(canonical_payload_bytes).

A primary signature may be generated over the transferkey_digest by a secure enclave, trusted execution environment, hardware security module, secure key store, institutional signer, or software signing module. If a risk score exceeds a policy threshold, a secondary guardian signature may be required. The TransferKey may be issued only when the required signatures, nonce state, policy state, terminal state, and revocation state are valid.

A TransKey may be derived from the TransferKey by computing H(transferkey_digest∥endpoint_id∥context_type∥one_time_use_flag∥expiration∥random_or_counter_value). The derived TransKey may be scoped to a particular communication session, payment request, navigation proof, device command, asset access request, API call, or verifier endpoint. The TransKey can be single-use or limited to a small number of operations according to policy.

The TransferKey is not merely a commercial label. It is a structured cryptographic authorization object. The TransKey is not merely a password or generic bearer token. It is bounded by RootedDomain credential state, access context, target endpoint, time window, nonce, revocation reference, and receipt record. This structure supports network security improvement because an access object cannot be freely replayed in a different context.

Canonical payload example:
canonical_payload = {source_rooted_domain_id, credential_id, terminal_id, context_type,
target_endpoint_id, permission_scope, nonce, time_window_start, time_window_end,
policy_version_id, route_descriptor_digest, credential_state_digest, revocation_reference,
intention_vector_hash, temporal_trust_score, receipt_pointer}
transferkey_digest = H(canonicalize(canonical_payload, canonical_profile_id))
transkey_digest = H(transferkey_digest ∥ target_endpoint_id ∥ context_type ∥ expiration ∥
one_time_use_flag ∥ derivation_counter)

### Replay Prevention and Time Window Control

Upon receiving an access request, the gateway may derive a nonce N as N=H(rooted_domain_id∥request_counter∥random_value∥context_type∥policy_version_id). The request_counter may be a monotonically increasing per-credential value retrieved from credential state or a route-state store. The random_value may be generated by a cryptographic random number generator. Alternative embodiments use server-issued nonces, endpoint-issued challenges, terminal counters, or deterministic sequence gates.

The gateway binds N to a validity window [t0, t0+delta], where t0 is the issuance time and delta is a context-specific lifetime. A payment context may use a short window, a communication context may use a session window, a device command may use a stricter window, and a navigation context may use a privacy-limited or route-limited window. The selected window is recorded in the TransferKey, derived TransKey, access object, and receipt.

Before issuing or accepting an access object, the gateway checks the consumed-nonce table or equivalent state store. If N is present and active, the request is rejected with a replay decision code. If the window expired, the request is rejected with a window-expired decision code. If the credential is suspended or revoked, the request is rejected or frozen. If the target endpoint or context differs from the canonical payload, the request is rejected as a context mismatch.

After successful issuance, the gateway inserts N into the consumed-nonce table with a time-to-live equal to the time window plus a clock-skew allowance. In a distributed embodiment, consumed-nonce tables may be sharded by RootedDomain prefix, terminal identifier, endpoint class, or route descriptor digest. In an offline embodiment, local consumed-nonce records may be reconciled after reconnection using timestamp ordering, signature verification, peer receipts, Merkle proof, or bounded rollback.

The replay-prevention mechanism is a technical feature independent of any business model. It changes the operation of the gateway by preventing reuse of an authorization object outside its intended time, endpoint, context, credential, or route state. A rejected replay event may still generate a signed non-activation receipt so that a verifier or dispute reviewer can determine why issuance or execution was refused.

### BEIGate Policy, Risk, Trust, and Toll Decision

The BEIGate authorization module receives credential state, policy state, terminal state, route descriptor, intention vector, temporal trust score, device state, endpoint capability, risk inputs, compliance pre-check state, fee or toll rule, revocation state, and nonce state. The module generates a gateway decision code including allow, reject, throttle, reroute, request-secondary-verification, quarantine, freeze, rollback, recover, or escalate.

In one embodiment, a risk score is computed from weighted components. For example, risk_score=w1*credential_anomaly+w2*device_mismatch+w3*route_risk+w4*value_limit+w5*trust_decay+w6*jurisdiction_flag+w7*prior_dispute+w8*offline_uncertainty. The weights may be policy controlled and may differ by communication, payment, navigation, device, AI-agent, robot, IoT, or asset context.

A temporal trust routing score may be received from an upstream intention navigation layer. The score may be based on urgency, temporal validity, trust weight, permission fit, endpoint availability, service capability, historical service quality, dispute status, privacy requirement, domain priority, and synchronization state. The gateway may require a higher trust score for device control, payment authorization, registry operation, or emergency broadcast than for low-risk information retrieval.

A toll or fee rule may be applied at gateway level. A toll rule can represent routing fee, verification fee, settlement referral fee, API call fee, device authorization fee, emergency priority fee, or proof export fee. The rule is not the primary invention; it is an optional gateway policy that can be recorded in the receipt and passed to a downstream accounting, sub-bank, wallet, BEIMINT, or index system.

The policy module may reference a PolicyContainer or policy version hash from a Genesis Terminal layer. A policy update may be accepted only when signed, versioned, and consistent with credential state. A TransferKey issued under one policy version remains verifiable later because the receipt stores the policy hash or policy version value used at issuance.

### Context-Specific Access Objects

### Communication Access Object

A communication access object may authorize a message, voice session, video session, asynchronous record, WebRTC session, SIP session, temporary channel, sessionless communication, or EmotionComm-compatible channel. Inputs may include source RootedDomain, target RootedDomain, voice state, mood state, intention state, communication endpoint, privacy rule, transcript hash policy, and receipt pointer. The object may be inserted into signaling headers, passed through a messaging API, or referenced by a verifier before the session begins.

For the communication access object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Payment or Remittance Authorization Object

A payment authorization object may bind payer RootedDomain, recipient or merchant RootedDomain, value descriptor, amount, currency or value type, time-derived contribution reference, rhythm or behavior proof, downstream wallet endpoint, compliance pre-check code, risk pre-check code, nonce, time window, TransferKey hash, and signed receipt pointer. The object may be consumed by a wallet, merchant, sub-bank, deterministic clearing kernel, payment network, or settlement endpoint. The gateway does not need to perform final settlement.

For the payment or remittance authorization object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Navigation Intent Object

A navigation intent object may use behavioral movement signal, presence proof, location confidence, route-intent data, privacy rule, endpoint class, route descriptor, time window, and intent path map. The navigation object may operate in GPS-denied, GPS-assisted, or privacy-limited environments. It should not be read as requiring universal replacement of satellite navigation; it provides a credential-bound route-intent proof and access object.

For the navigation intent object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Device, AI-Agent, Robot, Wallet, Vehicle, Sensor, or IoT Access Object

A device access object may authorize enrollment, binding, attestation, command, revocation, temporary delegation, maintenance, or remote update. The object may verify a scoped permission tree before allowing an AI-agent tool call, robot instruction, wallet call, vehicle instruction, sensor action, or IoT gateway command. Secure element or hardware attestation may be required for sensitive operations.

For the device, ai-agent, robot, wallet, vehicle, sensor, or iot access object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Asset Gate Object

An asset gate object may authorize access to, or request processing by, a digital asset endpoint, credential ledger, deterministic proof kernel, sub-bank contract interface, exchange endpoint, settlement endpoint, BEIGX endpoint, BEICurrency endpoint, TimeCurrency endpoint, ATMS service, or BEIMINT interface. The object is an entry permission and evidence package; execution of issuance, clearing, settlement, collateral liquidation, or exchange matching may occur in downstream systems.

For the asset gate object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Emergency or Priority Broadcast Object

In emergency or public-service embodiments, the gateway may generate a high-priority communication, navigation, device, medical, disaster, emergency, public-service, or priority-routing access object. The object may reference emergency RootedDomain namespaces, medical domains, public-service domains, or priority route descriptors and may require special receipts, escalation codes, and post-event audit.

For the emergency or priority broadcast object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Memory or Contribution Evidence Object

A signed gateway receipt may be exportable to a memory, contribution, or evidence record. The record may include receipt hash, access-object identifier, behavioral proof reference, witness reference, validation reference, disclosure scope, revocation state, and user-controlled publication rule. This supports Contribution NFT or memory-chain embodiments without making token issuance the required invention.

For the memory or contribution evidence object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Local-Global Bridge Object

A local-to-global bridge object may relay the access object between local terminals, private namespaces, public domains, cloud services, Web3 systems, AI-agent tools, IoT gateways, wallets, communication systems, and external rails. The object preserves source domain, credential status, context, time window, permission scope, receipt pointer, and revocation reference during interoperability.

For the local-global bridge object, the gateway may record both the positive issuance event and any non-activation event. A non-activation record can include request hash, endpoint class, policy reason, risk reason, nonce state, time-window state, terminal state, and reviewer reference. This allows the system to prove not only that an object was issued, but also why a requested object was not issued.

### Relationship to Intention Navigation and Domain Terminal Activation

An upstream intention navigation layer can convert a request event into an intention vector. The present gateway can use the intention vector to select an access-object template. For example, a medical alert may select an emergency communication object, a payment need may select a payment authorization object, a sensor alert may select an IoT command object, and a shipment exception may select a logistics endpoint object.

A temporal trust routing score can be used by BEIGate as a decision input. A candidate endpoint with high capability but stale trust may require secondary verification. A candidate endpoint with strong permission but poor availability may be rerouted. A candidate endpoint selected under emergency state may bypass ordinary scheduling but require enhanced receipt generation and post-event audit.

A context-specific access object generated by the gateway may be consumed by a domain terminal activation runtime. The runtime may cause an API call, wallet call, AI-agent tool call, IoT command, robot instruction, message notification, service reservation, emergency alert, registry operation, cross-domain relay, or verifier request, subject to the permission and receipt rules encoded in the access object.

A signed gateway receipt may be compatible with an ActionLedger evidence record. The receipt may include intention-vector hash, selected endpoint identifier, permission basis, route score, timestamp, cryptographic verification value, ledger-state hash, TransferKey digest, TransKey digest, revocation reference, decision code, and receipt pointer. This compatibility allows the access object to be audited together with endpoint selection evidence.

### Relationship to BEI×24HWS Sovereign Operating Layer

In some embodiments, the gateway may operate with a BEI×24HWS sovereign operating layer in which a person, device, wallet, AI agent, robot, terminal, institution, service endpoint, or domain resource is represented by a self-owned domain handle, ReadName identifier, BEI-ID, or equivalent domain-linked identity root. The gateway does not require a telephone number, SIM identifier, bank switch code, GPS coordinate, national identity number, or social platform account as the sole primary route identifier.

The gateway uses a RootedDomain credential, intention state, behavioral-time proof, policy state, nonce, time window, and signed receipt to generate a context-specific communication, payment, navigation, device, or asset access object. This technical formulation preserves the valuable 24HWS concepts while avoiding declaration-style language that would distract from the machine implementation.

EmotionComm-compatible communication may use voice, mood, intention, or behavioral-time proof as input to a communication access object. GeoNode-compatible navigation may use movement signal, presence proof, and location confidence in a navigation intent object. Time Wallet-compatible authorization may use time-derived contribution or rhythm proof in a payment or remittance authorization object. Contribution-chain concepts may be expressed as signed gateway receipts or evidence envelopes.

### Signed Gateway Receipt and Evidence Envelope

The signed gateway receipt provides a technical audit record. In one embodiment the receipt is generated for every issuance, rejection, freeze, rollback, escalation, or recovery event. The receipt can be verified independently of private behavioral data because it stores digests and references rather than necessarily exposing raw behavioral evidence.

The receipt may include primary and secondary signature fields. A primary signature may be generated by a secure enclave, trusted execution environment, secure key store, software key, institutional key, or hardware security module. A secondary guardian signature may be generated when a risk threshold is satisfied or when a route requires guardian, AI, institutional, multi-party, or manual confirmation.

The receipt may be exported as an evidence envelope. The evidence envelope may include credential hash, route descriptor digest, intention-vector hash, access-object identifier, TransferKey digest, TransKey digest, nonce, time-window value, revocation reference, decision code, reason code, signature material, TimeTape snapshot reference, ActionLedger reference, proof-set reference, QR verification reference, or ISO 20022 SupplementaryData reference.

In communication contexts, the receipt or access-object reference may be inserted into signaling headers such as SIP, WebRTC, messaging, or equivalent pre-session headers. In payment contexts, the receipt may be referenced from a structured message field, including an ISO 20022 SupplementaryData field or equivalent field, so that downstream payment, sub-bank, clearing, or compliance systems can retrieve authorization evidence without exposing private credential data.

In device and IoT contexts, the receipt may include device DID attestation, remote attestation reference, secure-element measurement fingerprint, periodic synchronization reference, command class, safety scope, controller identity, and revocation pointer. In asset contexts, the receipt may include asset endpoint reference, deterministic proof reference, exchange endpoint reference, or settlement request reference.

### Revocation, Freeze, Rollback, Recovery, and Lifecycle State

The gateway may refuse to generate a TransferKey when the upstream credential or terminal lifecycle state is draft, addressed but not sealed, review, freeze-simulation, suspended, revoked, expired, inherited without confirmation, compromised, or otherwise non-live. The gateway may permit issuance when the credential or terminal state is active, genesis-sealed, value-active, titled, terminal-live, recovered, or conditionally active according to policy.

Lifecycle states may include active, pending, suspended, review, frozen, revoked, expired, recovered, inherited, delegated, quarantined, rerouted, and rolled back. A transition table may specify the trigger, required proof, allowed output, receipt code, and next state. For example, a replay detected trigger may move a credential to review; a guardian-confirmed recovery may move it from suspended to recovered; an institutional breach notice may move it to frozen pending audit.

A rollback operation may reverse or constrain a route, access object, value event, permission state, or trust update without destroying the underlying audit record. A bounded rollback may mark an object invalid after a timestamp, prevent further use of related derived TransKeys, notify downstream verifiers, update revocation references, and preserve the receipt path for later dispute resolution.

Recovery may involve key rotation, guardian signature, institutional confirmation, time delay, peer receipts, device re-attestation, privacy-limited proof, or continuity evidence. Inheritance may transfer selected rights, endpoints, permissions, receipts, or terminal modules from a predecessor RootedDomain to a successor RootedDomain subject to policy, time, signature, and disclosure scope.

### Offline Operation and Resynchronization

The gateway may operate in disconnected or intermittent-network environments. A local terminal can issue provisional access objects or cache issuance requests when policy allows. The offline record may include request hash, RootedDomain reference, intention vector, route descriptor, local route score, selected endpoint, local signature, peer receipt, nonce state, conflict flag, and ledger-state hash.

Upon reconnection, the gateway or synchronization service may reconcile cached records by applying timestamp ordering, monotonic counter ordering, signature verification, quorum confirmation, conflict-free replicated data type rule, domain priority, permission priority, Merkle proof, proof-set validation, and bounded rollback. A conflict does not require deletion of the record; it may produce a disputed receipt, freeze state, or review route.

Offline operation is useful for emergency response, remote locations, disaster zones, field care, logistics, vehicle operations, IoT networks, and community governance. The technical benefit is continuity of authorization and evidence even when central connectivity is not continuously available.

### Security Model

Threats addressed by the gateway include credential replay, bearer-token leakage, endpoint substitution, policy downgrade, route descriptor tampering, stale trust score use, revoked credential use, device theft, SIM swap, wallet takeover, malicious AI-agent tool invocation, robot command abuse, IoT gateway compromise, receipt forgery, privacy over-disclosure, and downstream repudiation.

Replay threats are mitigated by nonce, time window, consumed-nonce table, context binding, endpoint binding, route descriptor digest, and revocation reference. Endpoint substitution is mitigated by target_endpoint_id and route_descriptor_digest in the canonical payload. Policy downgrade is mitigated by policy_version_id and policy_hash stored in the TransferKey and receipt.

Credential theft is mitigated by terminal-state checks, device attestation, secure enclave signatures, guardian signatures, risk thresholds, freeze state, and recovery mechanisms. Privacy over-disclosure is mitigated by evidence envelopes, limited proof, hash references, selective disclosure, zero-knowledge proof, and verifier endpoints that can validate receipt integrity without raw behavioral data.

Downstream repudiation is mitigated by signed gateway receipts, ActionLedger-compatible evidence, proof-set-compatible receipt pointers, TimeTape-compatible snapshots, ISO 20022 or structured message references, and API verifier endpoints. A downstream system can verify that the gateway authorized a request without taking control of the upstream credential.

### DETAILED WORKING EXAMPLES

### Example 1—Domain-Based Remittance

A payer RootedDomain requests to send a value descriptor to a recipient RootedDomain. The resolver returns credential state, policy state, and route descriptor. The intention vector identifies a remittance context and time window. BEIGate computes risk using value limit, prior disputes, endpoint reputation, and compliance pre-check code. A TransferKey canonical payload binds payer, recipient, amount or value descriptor, nonce, time window, downstream wallet endpoint, and receipt pointer. A payment authorization object is generated and transmitted to a downstream wallet or sub-bank endpoint. Settlement is performed outside the gateway; the gateway receipt records the authorization path.

### Example 2—SIM-Free Communication

A source RootedDomain initiates a voice or video session with a target RootedDomain. The request contains communication context, privacy rule, and optional voice or mood signal. The gateway verifies credential state, terminal state, and route descriptor. A communication TransKey is generated and referenced in a SIP or WebRTC header. The receiving endpoint verifies the header reference before session establishment. If the call is rejected, a non-activation receipt records the reason.

### Example 3—GeoNode-Compatible Navigation

A user or device requests a route-intent proof in a GPS-denied environment. The gateway receives presence proof, movement signal, and intent path request. The navigation object binds source RootedDomain, route-intent data, location confidence, privacy rule, time window, and receipt pointer. The object may authorize access to a navigation endpoint without exposing raw location history.

### Example 4—Device and IoT Command

An IoT gateway submits a sensor alert requiring a device command. The intention vector identifies urgency and endpoint class. The gateway checks scoped permission, device attestation, terminal lifecycle state, and risk score. If the command class is sensitive, an AI Guardian or institutional validator supplies secondary approval. A device access object authorizes a bounded command and writes a receipt containing device state and revocation pointer.

### Example 5—Asset Gate Request

A wallet terminal requests access to an exchange endpoint or deterministic clearing kernel. The gateway generates an asset gate object that references source RootedDomain, target endpoint, asset descriptor, TransferKey digest, policy version, proof-set reference, and receipt pointer. The downstream exchange or clearing system performs its own settlement or compliance processing. The gateway preserves evidence that access was authorized.

### Example 6—Replay Attack

An attacker attempts to reuse a previously issued TransKey. The gateway checks the consumed-nonce table and detects that the nonce is present. The gateway rejects the request, records REPLAY_DETECTED, freezes the route or credential if policy requires, and generates a signed non-activation receipt. The receipt allows review without exposing private behavioral evidence.

### Example 7—Lost Device Recovery

A user loses a device associated with a RootedDomain credential. Recovery rules require guardian confirmation, institutional confirmation, key rotation, and a delay. The gateway suspends issuance for high-risk contexts, permits limited recovery objects, and records each step as receipt entries. When recovery completes, new keys and revocation references are bound to future TransferKey or derived TransKey issuances.

### Example 8—Local-Global Bridge

A local community terminal issues a public-service access object during intermittent connectivity. The object is cached with local signature and peer receipt. After network reconnection, the object and receipt are synchronized with a global verifier using Merkle proof and timestamp ordering. Conflicts are marked for review rather than silently overwritten.

### Algorithmic and State Tables

| State | Trigger | Gateway action | Receipt output |
|---|---|---|---|
| active | valid credential, | issue | ALLOW with |
| | valid nonce, policy | TransferKey/TransKey | access_object_id |
| | satisfied | | |
| review | anomaly, dispute, | request secondary | ESCALATE with |
| | stale trust, policy | verification or reroute | reason_code |
| | mismatch | | |
| frozen | breach, replay | reject new high- | FREEZE with |
| | cluster, guardian | risk access objects | revocation_ref |
| | freeze, institutional | | |
| | hold | | |
| revoked | credential | deny issuance and | REVOKED with |
| | revoked or terminal | notify verifier | policy_hash |
| | non-live | | |
| recovered | key rotation and | issue under new | RECOVERED |
| | guardian | key and receipt chain | with continuity_ref |
| | confirmation | | |
| | complete | | |
| inherited | successor domain | issue only scoped | INHERITED with |
| | approved | successor objects | predecessor_ref |
| expired | time window or | deny or require | EXPIRED with |
| | credential validity | renewal | renewal_ref |
| | expired | | |
| | | | Downstream |
| Context | Required checks | Output object | boundary |
| communication | credential, | communication | messaging/voice/ |
| | endpoint, privacy, | access object | video endpoint |
| | session policy | | establishes session |
| payment/remittance | credential, value, | payment | wallet/sub- |
| | risk, time, | authorization object | bank/settlement |
| | payer/recipient | | system executes |
| navigation | credential, | navigation intent | navigation |
| | presence, route- | object | endpoint estimates |
| | intent, privacy | | route/path |
| device/IoT | credential, | device access | device gateway |
| | attestation, | object | executes bounded |
| | permission, command | | command |
| | class | | |
| asset/exchange | credential, asset | asset gate object | exchange/clearing |
| | descriptor, endpoint, | | kernel/sub-bank |
| | proof ref | | processes |
| emergency | credential, | priority | public-service or |
| | priority namespace, | access/broadcast | emergency endpoint |
| | policy, audit rule | object | acts |

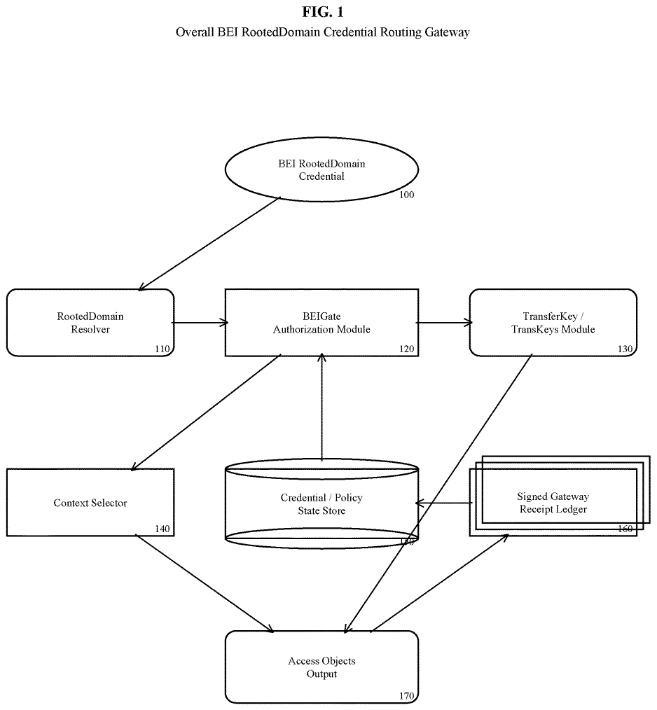

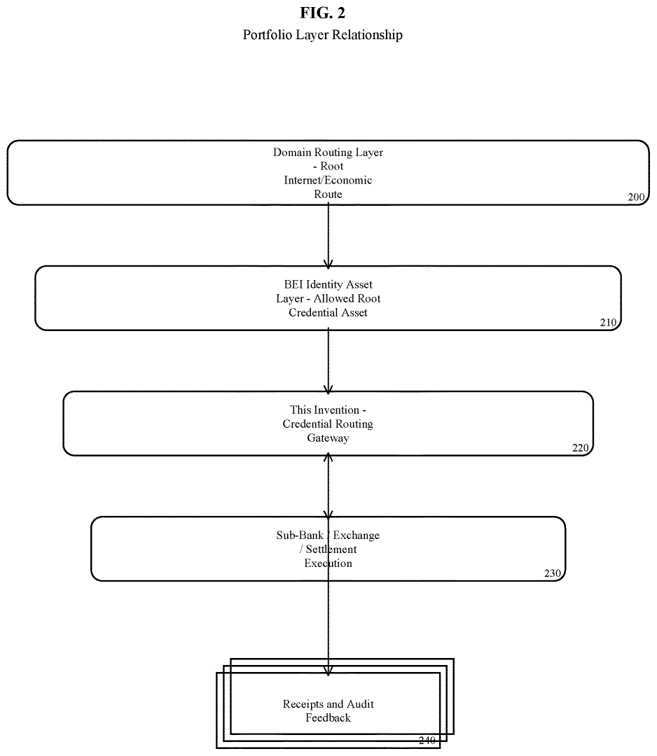

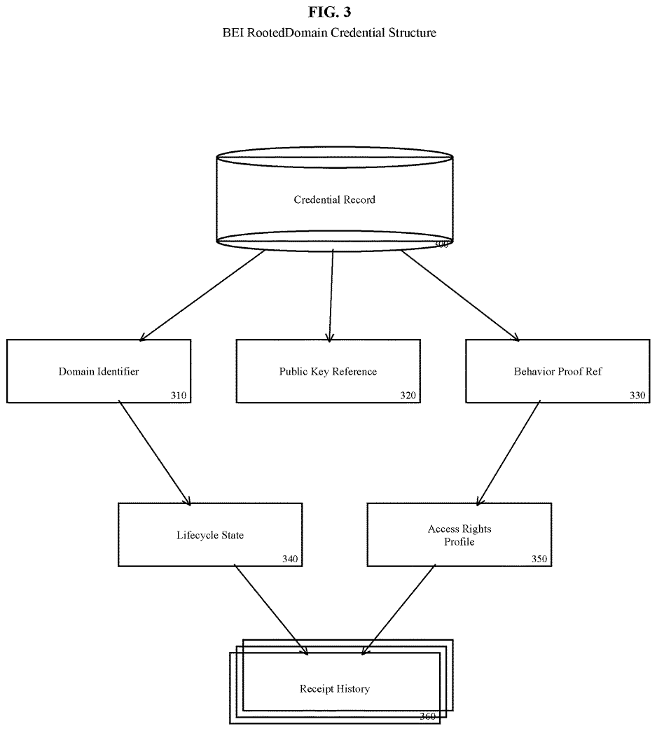

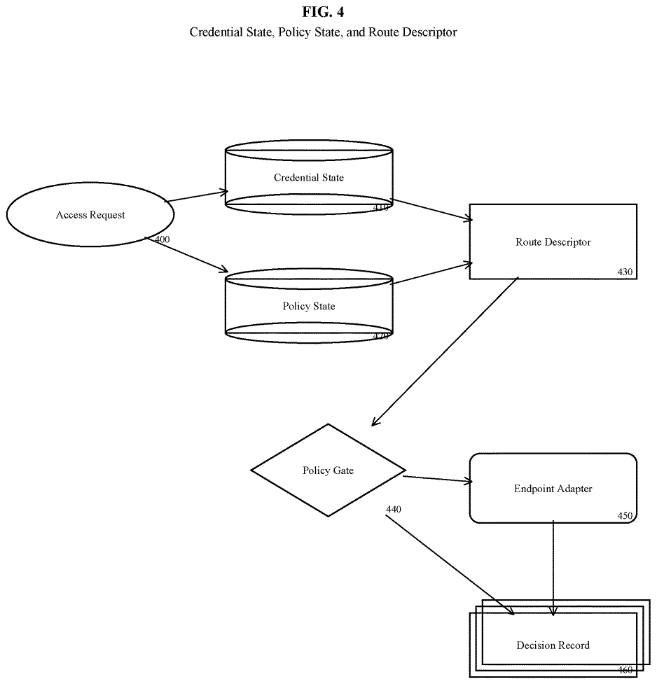

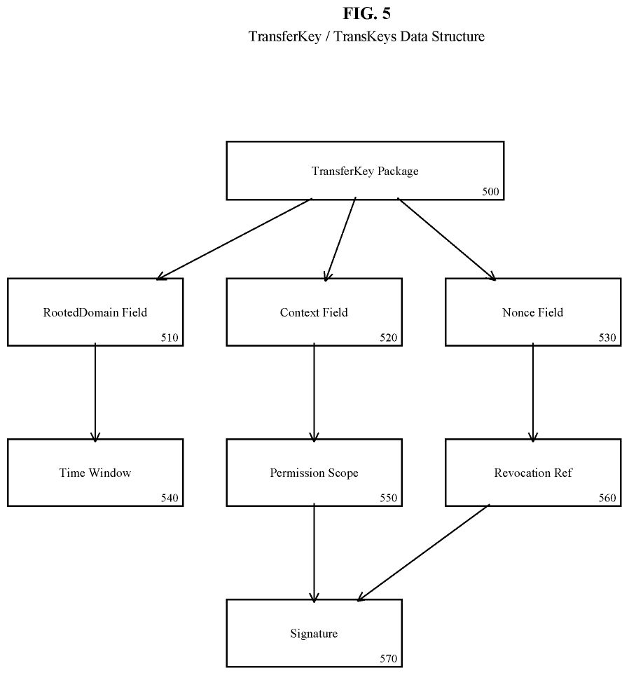

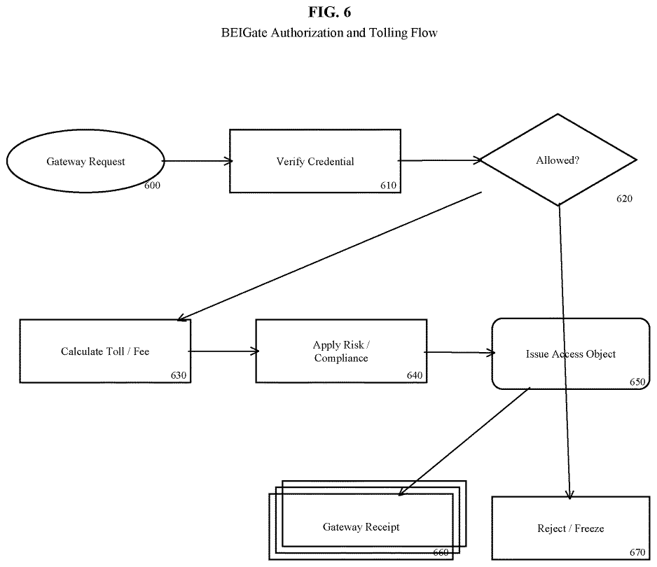

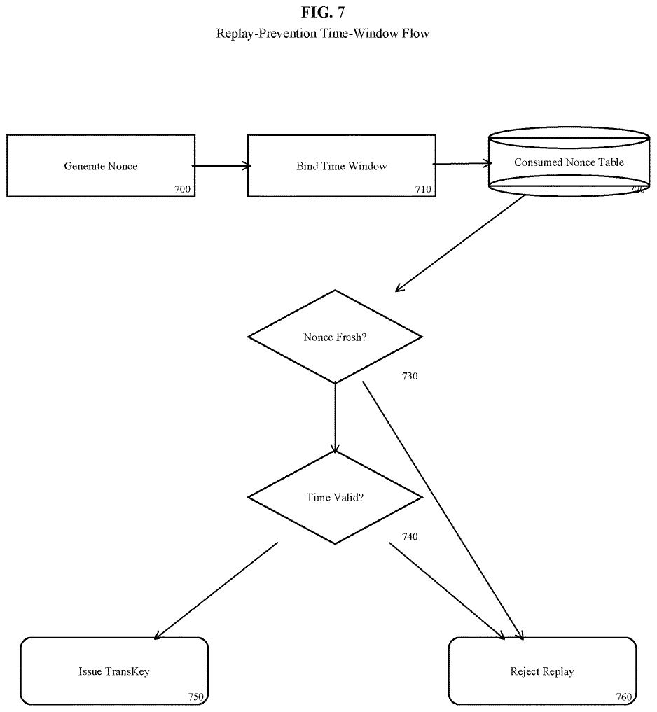

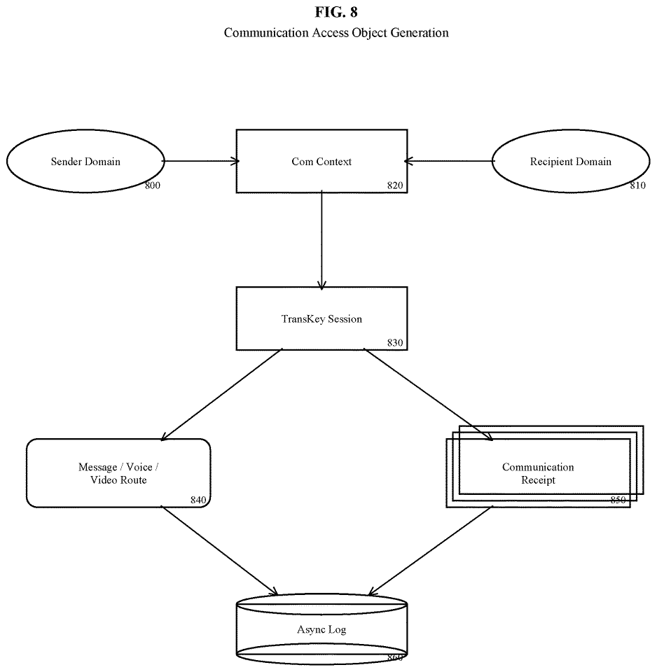

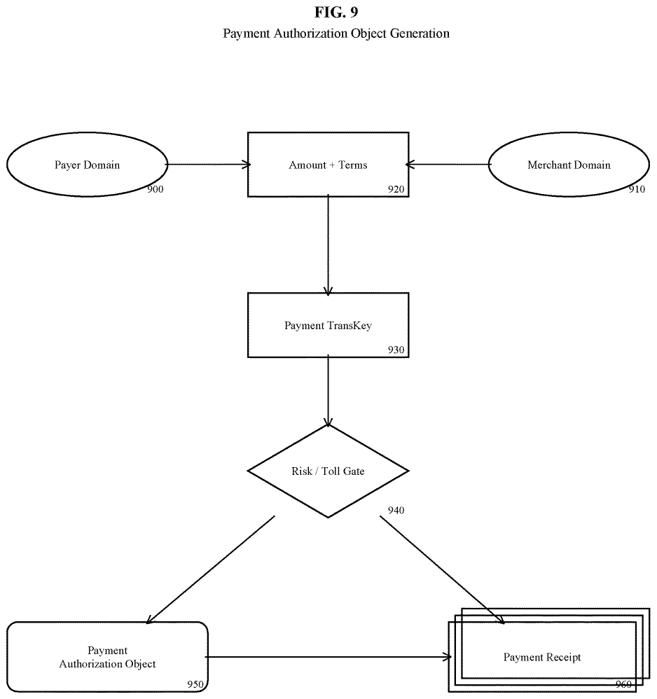

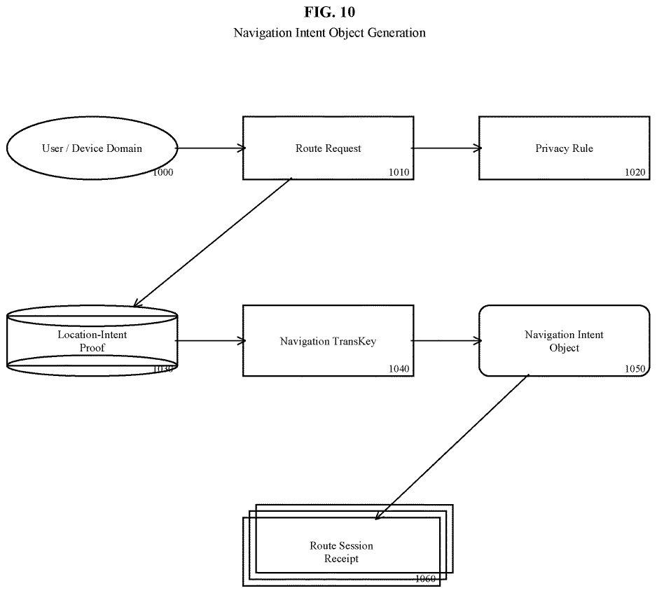

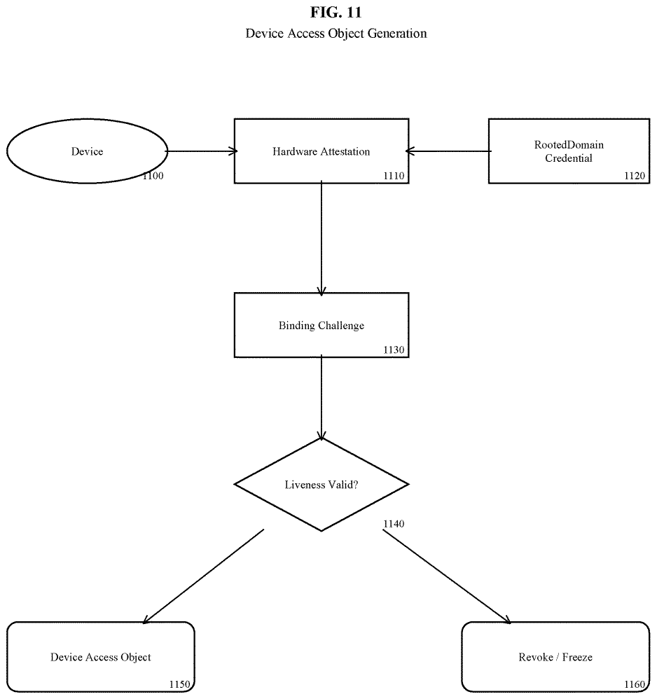

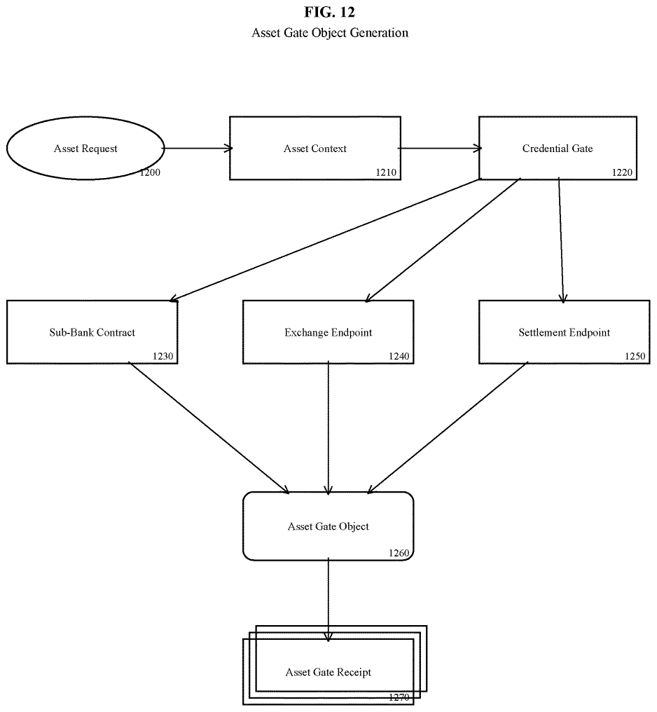

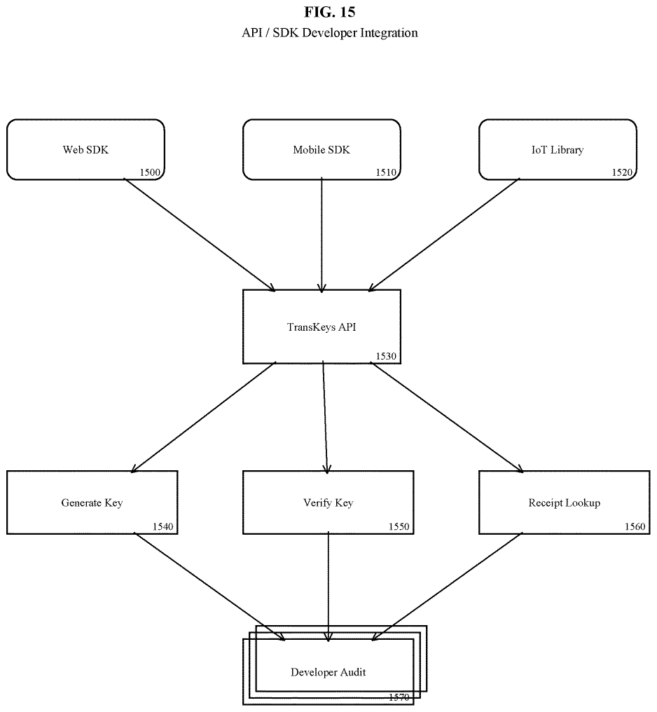

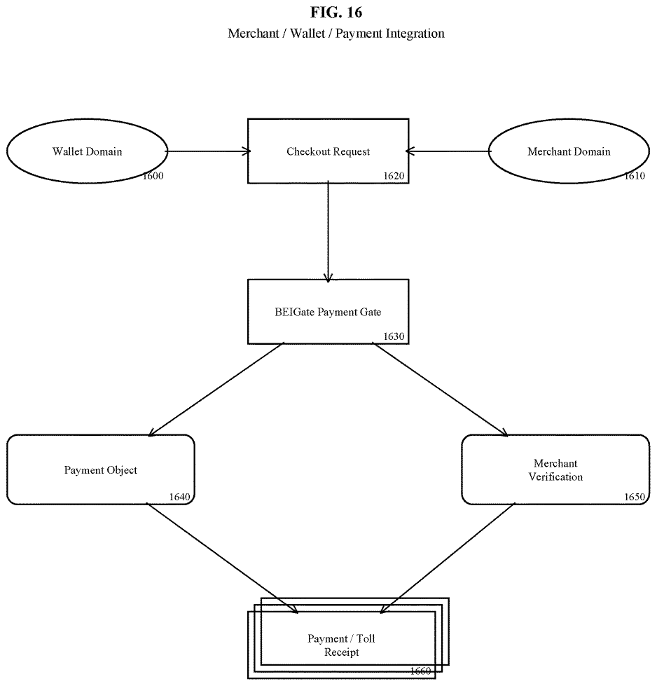

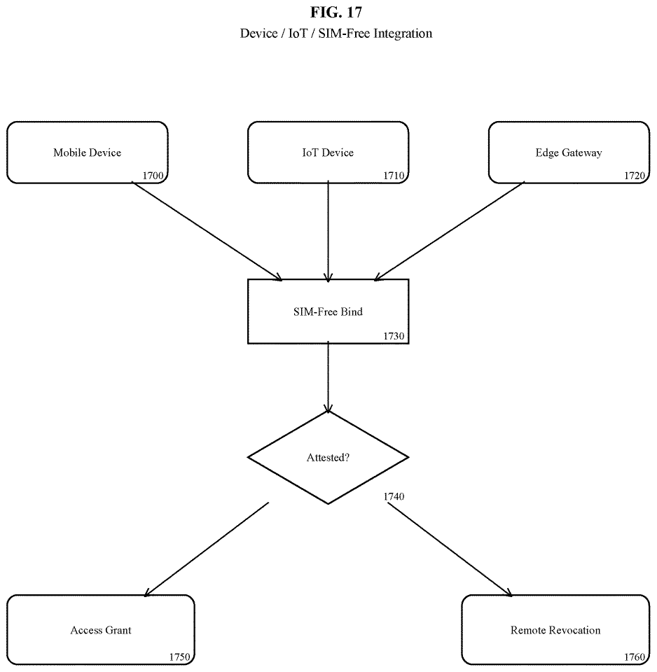

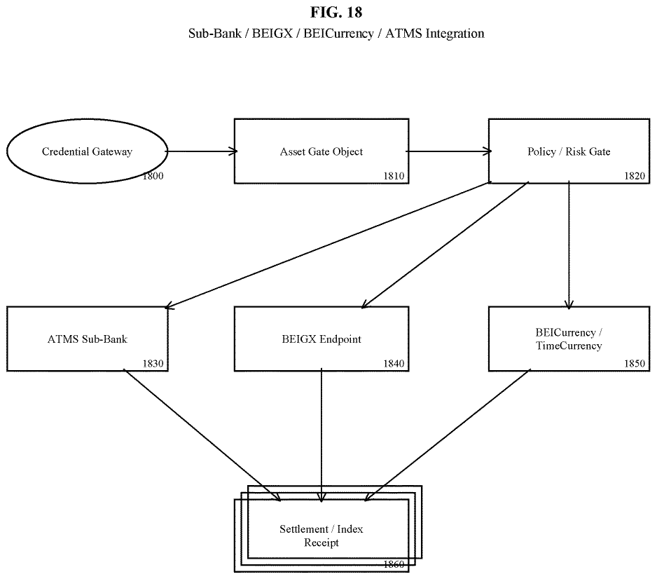

### Claim Support Matrix

| | Primary support | | |
|---|---|---|---|
| Claim group | in specification | Drawing support | Technical focus |
| Claim 1 system | resolver, credential | FIGS. 1-7, 13-14 | gateway |
| | verification, | | architecture |
| | TransferKey/TransKey, | | |
| | BEIGate, access object, | | |
| | receipt | | |
| Claims 2-7 | resolution | FIGS. 3-7, 13-14 | system fallback |
| | descriptor, behavioral | | features |
| | proof, short-lived key, | | |
| | policy/risk/toll, receipt, | | |
| | revocation | | |
| Claim 8 method | receive, resolve, | FIGS. 4-7, 8-12, 13 | credential-to- |
| | verify, nonce/time | | object method |
| | window, generate | | |
| | access object, output, | | |
| | record receipt | | |
| Claims 9-15 | communication, | FIGS. 8-12, 14, | context |
| | payment, navigation, | 16-18 | embodiments |
| | device, asset, fee, | | |
| | anomaly handling | | |
| Claim 16 CRM | software | FIGS. 1, 5-7, | SDK/API/software |
| | instructions for | 13-15 | layer |
| | resolver, key | | |
| | generation, policy gate, | | |
| | receipt, revocation | | |
| Claims 17-20 | API/SDK, lifecycle | FIGS. 15-18 | ecosystem |
| | sync, audit package, | | interfaces |
| | interfaces to domain | | |
| | routing, sub-bank, | | |
| | communication, | | |
| | payment, navigation, | | |
| | device systems | | |

### Portfolio Boundary Matrix

| | | Boundary relative to |
|---|---|---|
| Layer | Role | present 628 application |
| Identity Asset Layer | domain-tokenized identity | upstream credential |
| | asset and behavioral | source; not repeated as |
| | certification | primary gateway invention |
| Genesis Router/Identity | RootedDomain to BEI | provides terminal state, |
| Terminal | Identity Terminal, | policy hash, credential status, |
| | PolicyContainer, lifecycle | audit pointer |
| | state | |
| Domain Routing/ | namespace resolution, | provides route descriptor |
| Deterministic Proof Kernel | canonical route descriptor, | and proof-compatible |
| | nonce/proof-set mechanics | evidence; gateway does not |
| | | execute clearing kernel |
| BEISIGN Evidence Layer | dual signature, evidence | provides signing and |
| | envelope, TimeTape, | export embodiments for |
| | communication/payment | TransferKey and gateway |
| | overlays | receipt |
| Intention Navigation/ | intention vector, temporal | provides context selector |
| Temporal Trust Routing | trust score, endpoint | and endpoint trust inputs to |
| | selection, ActionLedger route | BEIGate |
| | evidence | |
| BEI × 24HWS Original | ReadName, | provides use-case |
| Sovereign Layer | EmotionComm, GeoNode, | embodiments converted into |
| | Time Wallet, Contribution | technical access objects and |
| | NFT, AI Guardian, local- | receipts |
| | global bridge | |
| Present 628 Gateway | TransferKey/TransKey, | central credential-to- |
| | BEIGate, context-specific | access-object gateway |
| | access object, signed gateway | |
| | receipt | |
| Sub-Bank/BEIGX/ | risk, compliance, | downstream systems may |
| BEICurrency/ATMS | settlement, clearing, | consume authorization |
| Execution | exchange, currency or index | objects; they are not required |
| | execution | gateway settlement functions |

### Industrial Applicability an Licensing Architecture

The gateway may be used by identity providers, DID wallets, passkey systems, communication platforms, payment gateways, merchant acquirers, checkout platforms, remittance systems, device manufacturers, IoT networks, telecom systems, SIM-free activation systems, navigation services, emergency systems, AI-agent platforms, robot control systems, cybersecurity vendors, API gateways, exchanges, sub-bank systems, deterministic proof kernels, and asset-route providers.

Licensing may be layered. A communication license may cover communication access objects and signaling-header verification. A payment license may cover payment authorization objects and downstream wallet or sub-bank interfaces. A device license may cover SIM-free device binding and remote revocation. An asset license may cover asset gate objects and exchange endpoint interfaces. An SDK license may cover TransferKey and derived TransKey generation APIs.

The invention is not limited to a particular brand, domain string, blockchain, cloud provider, AI model, mobile operating system, payment rail, messaging platform, or map provider. The protected corridor is the structured conversion of a RootedDomain credential into bounded, signed, replay-resistant, context-specific access objects with receipt and lifecycle control.

### 101 Eligibility Support

The claimed architecture is directed to a specific network-security and authorization-gateway improvement. It does not merely say to authenticate a user or perform a financial transaction. It defines a gateway that resolves credential state, policy state, route descriptor, context state, nonce, time window, revocation reference, and signed receipt to generate a machine-executable access object.

The ordered combination is non-conventional because a RootedDomain credential, intention vector, temporal trust score, TransferKey canonical payload, TransKey derivation, consumed-nonce replay gate, BEIGate decision code, and signed gateway receipt operate together. Removing any of these core elements reduces security, auditability, revocability, or multi-context interoperability.

The gateway improves computer operation by preventing replay, binding access objects to context and endpoint, providing verifier-compatible receipts, preserving revocation state, and allowing disconnected caching and later reconciliation. These are technical effects in computer networks, identity systems, API gateways, device access systems, and payment authorization systems.

### 112 Written Description and Enablement Support

The disclosure provides written description by identifying modules, data structures, field mappings, algorithms, state transitions, examples, and figure relationships. A person of ordinary skill in computer networking, identity management, cryptographic authorization, API gateways, distributed ledgers, payment authorization, device attestation, and software security can implement the gateway using conventional processors, memory, databases, APIs, cryptographic libraries, secure key stores, resolver services, and network protocols.

The disclosure enables multiple embodiments. It describes credential records, route descriptors, TransferKey packages, TransKey packages, access objects, gateway receipts, ActionLedger evidence records, evidence envelopes, replay logic, risk scoring, policy decisions, receipt export, offline operation, recovery, and downstream interface boundaries. Alternative field names and encodings may be used while preserving the claimed data relationships.

The disclosure avoids indefiniteness by defining BEI, BEI RootedDomain credential, RootedDomain resolver, TransferKey, derived TransKey, BEIGate, context-specific cryptographic access object, signed gateway receipt, intention vector, temporal trust routing score, ActionLedger-compatible evidence record, ReadName, EmotionComm-compatible communication, GeoNode-compatible navigation, Time Wallet-compatible authorization, and AI Guardian.

### 102 and 103 Technical Distinctions

Individual pieces such as short-lived tokens, nonces, wallets, device attestation, DID documents, API gateways, or payment authorization messages may be known. The novelty and non-obviousness of the present architecture lies in the ordered combination: BEI RootedDomain credential resolution, behavioral or terminal credential verification, intention/context selection, TransferKey canonical payload, TransKey derivation, replay-prevention state, BEIGate policy/risk/trust decision, context-specific access object, signed gateway receipt, and lifecycle control.

A conventional OAuth token or JWT is not the same as a TransferKey bound to RootedDomain credential state, route descriptor digest, intention-vector hash, temporal trust score, revocation reference, and signed gateway receipt. A conventional payment token is not the same as a payment authorization object that shares a gateway model with communication, navigation, device, and asset contexts.

A conventional DNS or domain routing system is not the same as a credential routing gateway that uses a domain-linked identity root to generate cryptographic access objects. A conventional ledger receipt is not the same as a gateway receipt generated at issuance time and bound to nonce, time window, access-object identifier, revocation state, and decision code.

### ALTERNATIVE EMBODIMENTS

The RootedDomain credential may be a public domain, private namespace, subdomain, ReadName, BEI-ID, DID, registry handle, wallet-bound domain, device-bound name, institutional domain, or application-domain alias.

The gateway may be deployed as a cloud service, local server, mobile application, browser extension, hardware gateway, edge node, wallet SDK, API gateway plugin, device management server, communication service, payment plugin, verifier endpoint, or decentralized network component.

The signed receipt may be stored as a database record, append-only log entry, Merkle tree leaf, distributed ledger transaction, local cache record, QR-verifiable package, evidence envelope, TimeTape snapshot, ActionLedger entry, or deterministic proof-set component.

The proof mechanism may use ECDSA, EdDSA, HMAC, threshold signature, multisig, secure enclave signature, hardware security module signature, guardian signature, zero-knowledge proof, hash commitment, selective disclosure credential, or post-quantum signature.

The gateway may use external map systems, payment rails, healthcare systems, education systems, logistics systems, energy systems, AI models, IoT clouds, blockchain networks, bank systems, exchanges, and communication platforms as subordinate services. Integration with external systems does not remove the gateway when the credential-to-access-object path remains present.

### Best Mode and Practical Deployment

A preferred practical deployment uses a BEI RootedDomain credential store, resolver service, policy version store, nonce service, TransferKey generation service, TransKey derivation service, BEIGate authorization service, receipt ledger, verifier API, local cache, and connectors for communication, payment, navigation, device, asset, and sub-bank endpoints.

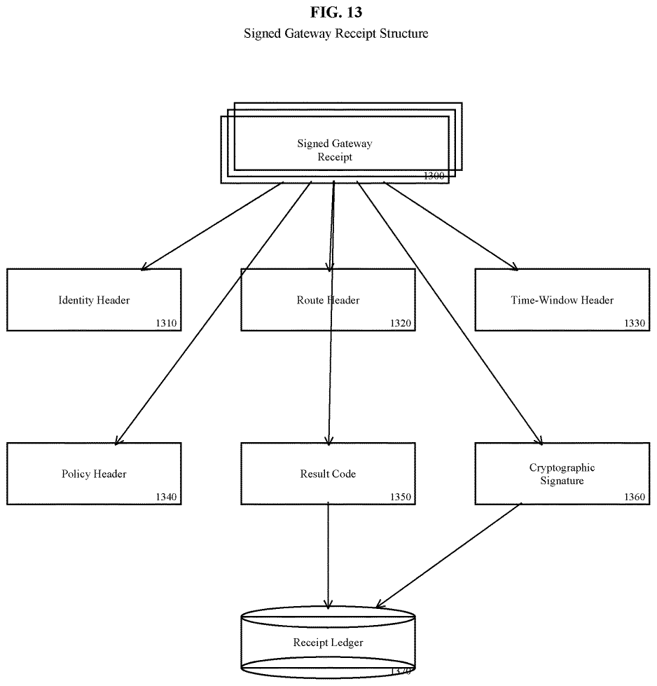

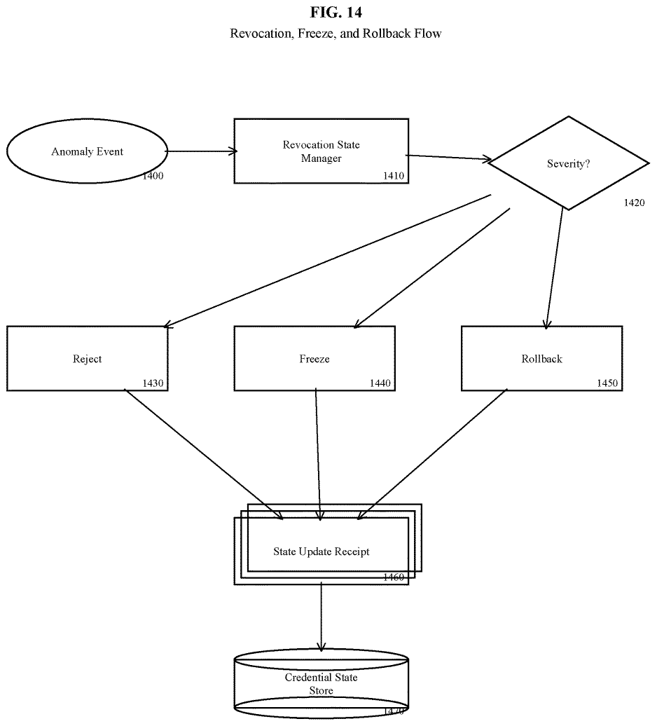

The preferred deployment maintains the drawings as functional architecture rather than user-interface decoration. Each figure corresponds to a claim family or specification module. FIGS. 1-7 support the gateway and key issuance core; FIGS. 8-12 support context access objects; FIGS. 13-14 support receipt and lifecycle; FIGS. 15-18 support SDK/API, communication, payment, device, asset, and downstream interfaces.

The preferred deployment keeps upstream and downstream layers separate. Upstream layers may generate identity assets, terminal states, policy containers, route descriptors, proof sets, intention vectors, or evidence envelopes. The present gateway consumes those inputs and produces a TransferKey, derived TransKeys, access objects, and receipts. Downstream layers may execute settlement, communication, device command, navigation service, or asset exchange.

### No New Matter Boundary Statement

The embodiments that reference BEI identity assets, Genesis Router, Domain Routing, deterministic proof, BEISIGN, Intention Navigation, 24HWS, ReadName, EmotionComm, GeoNode, Time Wallet, Contribution NFT, AI Guardian, local-global bridge, BEIGX, BEICurrency, TimeCurrency, ATMS, BEIMINT, BEIIndex, sub-bank, exchange, or settlement systems are presented as compatible interfaces, upstream sources, downstream destinations, or optional embodiments unless a claim expressly states otherwise.

The core invention of this application remains the BEI RootedDomain credential routing gateway that converts credential state into context-specific cryptographic access objects using TransferKey/TransKey issuance, replay prevention, policy/risk/trust decisioning, signed gateway receipts, and lifecycle control. This focus preserves the technical center and avoids converting the application into a general platform manifesto or financial execution engine.

The specification should be read with the claims. Examples and commercial names are included to provide enablement, working context, and anti-design-around explanation. They do not limit the claims unless expressly recited. Equivalent names, namespaces, protocols, ledgers, signatures, or endpoint systems may implement the same technical relationships.

### Conclusion

The disclosed gateway transforms a BEI RootedDomain credential into a set of bounded, signed, replay-resistant, revocable, auditable, and context-specific access objects. This gateway is the machine corridor between upstream BEI identity and route layers and downstream communication, payment, navigation, device, asset, and settlement systems.

The invention solves a concrete technical problem: fragmented identifiers cannot reliably authorize multi-context access while preserving replay prevention, endpoint binding, revocation, receipt evidence, and downstream interoperability. The gateway solves that problem by using a RootedDomain credential, TransferKey, derived TransKey, BEIGate policy decision, access-object template, nonce/time-window control, and signed gateway receipt.

The scope includes implementations that use different names or deployment environments while preserving the technical passage of credential resolution, verification, key generation, context-specific access object issuance, receipt storage, revocation, freeze, rollback, recovery, audit, and interface with upstream and downstream systems.

### Additional Technical Embodiment Details

### Merchant Verification Embodiment

In a merchant verification embodiment, the gateway may receive or generate fields including merchant RootedDomain, merchant terminal state, merchant endpoint certificate, amount limit, product or service descriptor, wallet endpoint, tax or compliance precheck, and signed receipt pointer. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The merchant verification embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Healthcare Route Embodiment

In a healthcare route embodiment, the gateway may receive or generate fields including patient RootedDomain, provider endpoint, consent scope, care urgency, medical privacy flag, emergency route descriptor, guardian state, and care receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The healthcare route embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Education Credential Embodiment

In a education credential embodiment, the gateway may receive or generate fields including learner RootedDomain, instructor endpoint, credential request, evidence hash, learning time window, reviewer signature, and certification receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The education credential embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Logistics Exception Embodiment

In a logistics exception embodiment, the gateway may receive or generate fields including shipment endpoint, sensor state, vehicle node, exception class, time deadline, trust score, service capability, and route evidence. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The logistics exception embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Energy and Utility Embodiment

In a energy and utility embodiment, the gateway may receive or generate fields including meter endpoint, outage state, storage endpoint, device command, load state, priority route, and technician authorization. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The energy and utility embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Legal and Compliance Embodiment

In a legal and compliance embodiment, the gateway may receive or generate fields including consent record, notary endpoint, evidence package, privacy-limited proof, filing endpoint, and review route. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The legal and compliance embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Civic Emergency Embodiment

In a civic emergency embodiment, the gateway may receive or generate fields including public-service domain, emergency route, responder endpoint, broadcast access object, post-event audit, and revocation after event window. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The civic emergency embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### AI-Agent Tool Embodiment

In a ai-agent tool embodiment, the gateway may receive or generate fields including agent identifier, tool call, model state reference, user approval, policy scope, secondary verifier, and tool execution receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The ai-agent tool embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Robot or Vehicle Embodiment

In a robot or vehicle embodiment, the gateway may receive or generate fields including controller RootedDomain, command class, safety policy, hardware attestation, route score, bounded actuation, and command receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The robot or vehicle embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### IoT Sensor Embodiment

In a iot sensor embodiment, the gateway may receive or generate fields including sensor endpoint, gateway identity, alert class, calibration state, maintenance route, command permission, and synchronization receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The iot sensor embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Domain Inheritance Embodiment

In a domain inheritance embodiment, the gateway may receive or generate fields including predecessor domain, successor domain, trigger event, guardian approval, key rotation, continuity evidence, and limited transfer receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The domain inheritance embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Privacy Disclosure Embodiment

In a privacy disclosure embodiment, the gateway may receive or generate fields including raw behavioral evidence, limited proof, hash commitment, verifier request, disclosure scope, and audit trail. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The privacy disclosure embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Contribution Evidence Embodiment

In a contribution evidence embodiment, the gateway may receive or generate fields including action log, witness reference, contribution proof, value descriptor, memory record, and user-controlled publication state. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The contribution evidence embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Index Update Embodiment

In a index update embodiment, the gateway may receive or generate fields including signed contribution, route result, value interface, index state, policy version, and downstream BEIIndex update. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The index update embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Cross-Platform Interoperability Embodiment

In a cross-platform interoperability embodiment, the gateway may receive or generate fields including web service endpoint, Web3 endpoint, AI agent, IoT gateway, cloud application, wallet, and local-to-global bridge reference. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The cross-platform interoperability embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Verifier API Embodiment

In a verifier api embodiment, the gateway may receive or generate fields including receipt identifier, access object hash, credential hash, policy hash, revocation reference, proof set, and verification result. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The verifier api embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Revocation Propagation Embodiment

In a revocation propagation embodiment, the gateway may receive or generate fields including revocation event, an affected TransferKey, affected derived TransKeys, endpoint notification, verifier cache update, and rollback receipt. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The revocation propagation embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Audit Package Embodiment

In a audit package embodiment, the gateway may receive or generate fields including signed receipt, route descriptor, credential verification result, policy decision record, evidence envelope, proof reference, and export signature. These fields are not merely labels; they determine whether the gateway issues a TransferKey, derives a TransKey, rejects a request, requests secondary verification, or stores a signed gateway receipt. The embodiment uses the same root corridor of credential state, policy state, route descriptor, nonce, time window, access object, and receipt, while varying the endpoint-specific payload to match the industry or device context.

The audit package embodiment also demonstrates how the gateway can interoperate with adjacent systems without absorbing their primary functions. The gateway may deliver an access object to a downstream service and may record an evidence package that later supports audit, licensing, recovery, rollback, or value-interface processing. The downstream service may perform its own execution, settlement, care delivery, device action, or record update under its own rules.

### Expanded Protocol Implementation Detail

The following implementation detail is included to keep the disclosure fully enabled while preserving the central 628 invention. The detail does not convert the application into the upstream identity, Genesis, domain-routing, BEISIGN, intention-navigation, 24HWS, or sub-bank applications. Instead, it defines how their useful outputs are consumed by the present gateway and converted into a TransferKey, derived TransKeys, context-specific access objects, and signed gateway receipts.

### RootedDomain Resolution Protocol

The rooteddomain resolution protocol begins when the gateway receives a credential request. The gateway treats the protocol as a machine operation rather than as a presentation layer because the input fields determine whether downstream endpoint activation can occur. Representative input fields include RootedDomain identifier, optional ReadName, DID reference, terminal identifier, route namespace, requested context, and caller signature. The gateway validates field format, credential scope, policy version, time window, signature status, and any context-specific constraints before passing the data to the next protocol stage.

Processing in the rooteddomain resolution protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the rooteddomain resolution protocol includes resolution descriptor, credential state, policy state, route descriptor digest, revocation reference, and terminal-state reference. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Credential Verification Protocol

The credential verification protocol begins when the gateway receives a resolved credential state. The gateway treats the protocol as a machine operation rather than as a presentation layer because the input fields determine whether downstream endpoint activation can occur. Representative input fields include behavioral proof reference, device attestation reference, identity asset reference, terminal lifecycle state, policy hash, guardian status, and prior receipt state. The gateway validates field format, credential scope, policy version, time window, signature status, and any context-specific constraints before passing the data to the next protocol stage.

Processing in the credential verification protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the credential verification protocol includes verified credential decision, proof digest, risk flags, and allowable context set. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Intention Context Protocol

The intention context protocol begins when the gateway receives a request event. The gateway treats the protocol as a machine operation rather than as a presentation layer because the input fields determine whether downstream endpoint activation can occur. Representative input fields include intention vector, demand category, urgency, time window, endpoint class, privacy flag, domain preference, and trust routing score. The gateway validates field format, credential scope, policy version, time window, signature status, and any context-specific constraints before passing the data to the next protocol stage.

Processing in the intention context protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the intention context protocol includes selected access context and context-specific payload template. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### TransferKey Issuance Protocol

The transferkey issuance protocol begins when the gateway receives a verified credential and selected context. The gateway treats the protocol as a machine operation rather than as a presentation layer because the input fields determine whether downstream endpoint activation can occur. Representative input fields include canonical payload fields, nonce, time window, route descriptor digest, endpoint reference, policy version, revocation state, and receipt pointer. The gateway validates field format, credential scope, policy version, time window, signature status, and any context-specific constraints before passing the data to the next protocol stage.

Processing in the transferkey issuance protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the transferkey issuance protocol includes signed TransferKey package and initial gateway receipt entry. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### TransKey Derivation Protocol

The transkey derivation protocol begins when the gateway receives a issued TransferKey. The gateway treats the protocol as a machine operation rather than as a presentation layer because the input fields determine whether downstream endpoint activation can occur. Representative input fields include target endpoint, session or transaction scope, expiration, one-time-use flag, derivation counter, context type, and endpoint policy. The gateway validates field format, credential scope, policy version, time window, signature status, and any context-specific constraints before passing the data to the next protocol stage.

Processing in the transkey derivation protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the transkey derivation protocol includes short-lived TransKey or access object for endpoint consumption. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Endpoint Delivery Protocol

The endpoint delivery protocol begins when the gateway receives a access object. The gateway treats the protocol as a machine operation rather than as a presentation layer because the input fields determine whether downstream endpoint activation can occur. Representative input fields include delivery channel, verifier endpoint, communication header, payment message field, wallet endpoint, device gateway, navigation service, or asset endpoint. The gateway validates field format, credential scope, policy version, time window, signature status, and any context-specific constraints before passing the data to the next protocol stage.

Processing in the endpoint delivery protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the endpoint delivery protocol includes acknowledgment, rejection, downstream status reference, or non-activation evidence. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Receipt Export Protocol

The receipt export protocol begins when the gateway receives a gateway decision event. The gateway treats the protocol as a machine operation rather than as a presentation layer because the input fields determine whether downstream endpoint activation can occur. Representative input fields include access object identifier, TransferKey digest, TransKey digest, nonce, time window, decision code, reason code, signatures, proof references, and disclosure scope. The gateway validates field format, credential scope, policy version, time window, signature status, and any context-specific constraints before passing the data to the next protocol stage.

Processing in the receipt export protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the receipt export protocol includes ActionLedger-compatible record, evidence envelope, proof-set pointer, QR verifier reference, or TimeTape-compatible snapshot. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Lifecycle Control Protocol

The lifecycle control protocol begins when the gateway receives a credential, endpoint, or receipt event. The gateway treats the protocol as a machine operation rather than as a presentation layer because the input fields determine whether downstream endpoint activation can occur. Representative input fields include revocation signal, freeze trigger, replay detection, guardian hold, policy update, recovery request, inheritance event, or rollback command. The gateway validates field format, credential scope, policy version, time window, signature status, and any context-specific constraints before passing the data to the next protocol stage.

Processing in the lifecycle control protocol may be synchronous for low-latency API calls or asynchronous for offline, device, payment, or cross-domain relay events. Intermediate state can be stored in a route-state object that includes current stage, prior stage digest, actor identifier, endpoint reference, risk flags, and partial receipt pointer. This prevents later modules from treating an unverified string as an authorized access object.

The output of the lifecycle control protocol includes state update, affected-object list, revocation pointer, rollback receipt, recovery receipt, or verifier notification. A successful output can be consumed by the next gateway module. A failed output can still produce a signed non-activation receipt. This detail is important because the invention records both allowed and refused access decisions, allowing later audit without requiring exposure of raw behavioral evidence or private credential material.

### Canonical Field Mapping for Context Objects

For the communication context, a context-specific access object may include the following representative fields: source_rooted_domain; target_rooted_domain; channel_type; signaling_protocol; privacy_scope; session_lifetime; transcript hash_policy; communication transkey_id; receipt_pointer; revocation_reference. The fields are selected so that endpoint systems can verify source identity, target endpoint, permission scope, lifetime, revocation state, and receipt path without requiring the gateway to perform the downstream service itself.

A communication access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the payment context, a context-specific access object may include the following representative fields: payer_rooted_domain; recipient_or_merchant_rooted_domain; value_descriptor; amount; currency_or_value type; remittance_context; compliance_precheck_code; wallet endpoint; sub_bank_endpoint_ref; receipt_pointer. The fields are selected so that endpoint systems can verify source identity, target endpoint, permission scope, lifetime, revocation state, and receipt path without requiring the gateway to perform the downstream service itself.

A payment access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the navigation context, a context-specific access object may include the following representative fields: source_rooted_domain; navigation_context; movement_signal_ref, presence_proof_ref; location_confidence; route_intent_hash; privacy_rule; endpoint_class; navigation_transkey_id; receipt_pointer. The fields are selected so that endpoint systems can verify source identity, target endpoint, permission scope, lifetime, revocation state, and receipt path without requiring the gateway to perform the downstream service itself.

A navigation access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the device context, a context-specific access object may include the following representative fields: controller_rooted_domain; device_identifier; hardware_attestation_ref; command_class; safety_scope; permission_tree_ref; expiration; remote_revocation_ref, device_transkey_id; receipt_pointer. The fields are selected so that endpoint systems can verify source identity, target endpoint, permission scope, lifetime, revocation state, and receipt path without requiring the gateway to perform the downstream service itself.

A device access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the AI-agent context, a context-specific access object may include the following representative fields: user_rooted_domain; agent identifier; tool_name; model_orpolicy ref, instruction_hash; approval_scope; secondary_guardian_flag; execution_limit; receipt_pointer. The fields are selected so that endpoint systems can verify source identity, target endpoint, permission scope, lifetime, revocation state, and receipt path without requiring the gateway to perform the downstream service itself.

A AI-agent access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the robot/vehicle context, a context-specific access object may include the following representative fields: controller_rooted_domain; robot_or_vehicle_id; command_vector_hash; physical_safety_rule; route_score; human_confirmation_flag; actuation_limit; rollback_instruction_ref; receipt pointer. The fields are selected so that endpoint systems can verify source identity, target endpoint, permission scope, lifetime, revocation state, and receipt path without requiring the gateway to perform the downstream service itself.

A robot/vehicle access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the IoT/sensor context, a context-specific access object may include the following representative fields: sensor_id; gateway_id; calibration_state; alert_class; telemetry_hash; maintenance_endpoint; command_permission; local_cache_state; synchronization_pointer. The fields are selected so that endpoint systems can verify source identity, target endpoint, permission scope, lifetime, revocation state, and receipt path without requiring the gateway to perform the downstream service itself.

A IoT/sensor access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the asset context, a context-specific access object may include the following representative fields: source_rooted_domain; asset_descriptor; exchange_endpoint; deterministic_proof_ref; sub_bank_contract_ref; settlement_request_ref; access_scope; proof_set_ref; asset gate_id; receipt_pointer. The fields are selected so that endpoint systems can verify source identity, target endpoint, permission scope, lifetime, revocation state, and receipt path without requiring the gateway to perform the downstream service itself.

A asset access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the emergency context, a context-specific access object may include the following representative fields: source_domain; emergency_namespace; priority_code; medical_or_public_service_flag; target endpoint; broadcast_scope; post_event_audit_rule; expiration; receipt_pointer. The fields are selected so that endpoint systems can verify source identity, target endpoint, permission scope, lifetime, revocation state, and receipt path without requiring the gateway to perform the downstream service itself.

A emergency access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

For the memory/contribution context, a context-specific access object may include the following representative fields: action_log_hash; contribution_descriptor; witness_ref, value_audit_ref, memory_record_scope; NFT_or_evidence_ref; disclosure_rule; user_control_flag; receipt_pointer. The fields are selected so that endpoint systems can verify source identity, target endpoint, permission scope, lifetime, revocation state, and receipt path without requiring the gateway to perform the downstream service itself.

A memory/contribution access object may be rejected when its context type is used outside the declared endpoint class, when its time window expires, when its nonce is consumed, when its route descriptor digest does not match the endpoint, when the credential is revoked, or when a required guardian, hardware, or institutional signature is missing. The rejection is recorded as a gateway receipt with a reason code.

### Non-Limiting Message Flow Examples

### Communication Message Flow

A source terminal requests a voice session. The gateway resolves source and target RootedDomains, checks policy, receives a communication intention vector, computes risk, issues a communication TransKey, inserts a receipt reference into a signaling header, and records a session-initiation receipt. If the target terminal rejects the session, the receipt is updated with a non-activation status.

The communication message flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Payment Message Flow

A payer wallet requests a remittance. The gateway verifies payer and recipient RootedDomains, binds a value descriptor and time-value reference into the canonical payload, checks risk and temporal trust score, issues a payment authorization object, sends it to a downstream wallet or sub-bank endpoint, and records that settlement is downstream rather than executed by the gateway.

The payment message flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Navigation Message Flow

A terminal requests navigation to a service endpoint while preserving privacy. The gateway receives presence proof and route-intent data, issues a navigation intent object, stores location confidence rather than raw location when policy requires, and allows a navigation service to return a route or path estimate. The receipt stores the privacy-limited proof and route-intent hash.

The navigation message flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Device Command Flow

A sensor alert requests an IoT command. The gateway verifies device attestation, scoped permission, controller identity, and risk threshold. A device access object is generated only for a bounded command class and expiration. The device gateway verifies the object and reports command status back to the receipt ledger.

The device command flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### AI Guardian Flow

A high-risk access request exceeds a policy threshold. The gateway pauses issuance and requests a guardian confirmation from a local AI guardian, secure enclave, human controller, institutional validator, or multi-party signer. Only after secondary approval does the gateway issue the TransferKey; otherwise it generates a non-activation receipt.

The ai guardian flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Asset Endpoint Flow

A RootedDomain requests entry to an exchange or asset endpoint. The gateway generates an asset gate object with proof-set reference and route descriptor digest. The exchange endpoint verifies the object and performs any separate settlement, exchange, compliance, or clearing operation. The gateway receipt remains the authorization evidence.

The asset endpoint flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Offline Cache Flow

A field terminal loses connectivity after generating a provisional access object. The terminal stores nonce, local signature, peer receipt, route descriptor digest, and local receipt hash in an offline vault. Upon reconnection, the gateway reconciles the record using signature verification, Merkle proof, timestamp order, and bounded rollback rules.

The offline cache flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

### Recovery Flow

A credential owner reports loss of a device. The gateway freezes high-risk contexts, allows only recovery objects, requires guardian or institutional proof, rotates keys, invalidates affected derived TransKeys, and writes continuity receipts. Downstream verifiers can detect that older objects were revoked after the recovery event.

The recovery flow is exemplary. The same gateway modules can be deployed with different APIs, signaling systems, ledgers, namespaces, or device vendors. What remains constant is the resolution of a RootedDomain credential into policy-bound, nonce-bound, time-bound, signed access evidence.

Failure Codes and Receipt Reasoning

| Code | Condition | Gateway action |
|---|---|---|
| REPLAY_DETECTED | nonce already | reject, optionally freeze |
| | consumed or replayed | route or credential |
| | outside approved path | |
| WINDOW_EXPIRED | time window exceeded | reject and require new |
| | or clock skew outside | TransferKey |
| | tolerance | |
| CONTEXT_MISMATCH | object used for | reject and record |
| | different context or | attempted context |
| | endpoint | |
| CREDENTIAL_REVOKED | credential state | deny issuance and |
| | indicates revoked, | update verifier cache |
| | suspended, or non-live | |
| POLICY_MISMATCH | policy version, | reroute, request |
| | permission scope, or | confirmation, or reject |
| | terminal state invalid | |
| TRUST_TOO_LOW | temporal trust score | request secondary |
| | below context threshold | verification or select |
| | | alternative endpoint |
| GUARDIAN_REQUIRED | risk score exceeds | pause issuance and |
| | threshold requiring | request guardian signature |
| | secondary approval | |
| DEVICE_ATTESTATION_FAILED | hardware, secure | deny device access |
| | enclave, or device proof | object |
| | invalid | |
| DOWNSTREAM_UNAVAILABLE | target endpoint | record non-activation |
| | unavailable or cannot | and optionally reroute |
| | verify object | |
| PRIVACY_SCOPE_EXCEEDED | requested disclosure | issue limited proof or |
| | exceeds policy or consent | reject |
| | scope | |
| OFFLINE_CONFLICT | cached offline record | mark disputed and |
| | conflicts on reconnection | invoke bounded rollback |
| SETTLEMENT_BOUNDARY | downstream financial | record authorization |
| | execution not performed | only and pass object |
| | by gateway | onward |

The REPLAY_DETECTED reason code is included to make gateway decisions machine-verifiable. When the condition occurs because nonce already consumed or replayed outside approved path, the gateway may reject, optionally freeze route or credential. Recording this code in a signed receipt prevents later ambiguity and allows downstream systems to distinguish a security refusal from a business decline, network failure, or missing endpoint.

The WINDOW_EXPIRED reason code is included to make gateway decisions machine-verifiable. When the condition occurs because time window exceeded or clock skew outside tolerance, the gateway may reject and require new TransferKey. Recording this code in a signed receipt prevents later ambiguity and allows downstream systems to distinguish a security refusal from a business decline, network failure, or missing endpoint.

The CONTEXT_MISMATCH reason code is included to make gateway decisions machine-verifiable. When the condition occurs because object used for different context or endpoint, the gateway may reject and record attempted context. Recording this code in a signed receipt prevents later ambiguity and allows downstream systems to distinguish a security refusal from a business decline, network failure, or missing endpoint.

The CREDENTIAL_REVOKED reason code is included to make gateway decisions machine-verifiable. When the condition occurs because credential state indicates revoked, suspended, or non-live, the gateway may deny issuance and update verifier cache. Recording this code in a signed receipt prevents later ambiguity and allows downstream systems to distinguish a security refusal from a business decline, network failure, or missing endpoint.

The POLICY_MISMATCH reason code is included to make gateway decisions machine-verifiable. When the condition occurs because policy version, permission scope, or terminal state invalid, the gateway may reroute, request confirmation, or reject. Recording this code in a signed receipt prevents later ambiguity and allows downstream systems to distinguish a security refusal from a business decline, network failure, or missing endpoint.

The TRUST_TOO_LOW reason code is included to make gateway decisions machine-verifiable. When the condition occurs because temporal trust score below context threshold, the gateway may request secondary verification or select alternative endpoint. Recording this code in a signed receipt prevents later ambiguity and allows downstream systems to distinguish a security refusal from a business decline, network failure, or missing endpoint.

The GUARDIAN REQUIRED reason code is included to make gateway decisions machine-verifiable. When the condition occurs because risk score exceeds threshold requiring secondary approval, the gateway may pause issuance and request guardian signature. Recording this code in a signed receipt prevents later ambiguity and allows downstream systems to distinguish a security refusal from a business decline, network failure, or missing endpoint.

The DEVICE_ATTESTATION_FAILED reason code is included to make gateway decisions machine-verifiable. When the condition occurs because hardware, secure enclave, or device proof invalid, the gateway may deny device access object. Recording this code in a signed receipt prevents later ambiguity and allows downstream systems to distinguish a security refusal from a business decline, network failure, or missing endpoint.

The DOWNSTREAM_UNAVAILABLE reason code is included to make gateway decisions machine-verifiable. When the condition occurs because target endpoint unavailable or cannot verify object, the gateway may record non-activation and optionally reroute. Recording this code in a signed receipt prevents later ambiguity and allows downstream systems to distinguish a security refusal from a business decline, network failure, or missing endpoint.

The PRIVACY_SCOPE_EXCEEDED reason code is included to make gateway decisions machine-verifiable. When the condition occurs because requested disclosure exceeds policy or consent scope, the gateway may issue limited proof or reject. Recording this code in a signed receipt prevents later ambiguity and allows downstream systems to distinguish a security refusal from a business decline, network failure, or missing endpoint.

The OFFLINE_CONFLICT reason code is included to make gateway decisions machine-verifiable. When the condition occurs because cached offline record conflicts on reconnection, the gateway may mark disputed and invoke bounded rollback. Recording this code in a signed receipt prevents later ambiguity and allows downstream systems to distinguish a security refusal from a business decline, network failure, or missing endpoint.

The SETTLEMENT_BOUNDARY reason code is included to make gateway decisions machine-verifiable. When the condition occurs because downstream financial execution not performed by gateway, the gateway may record authorization only and pass object onward.

Recording this code in a signed receipt prevents later ambiguity and allows downstream systems to distinguish a security refusal from a business decline, network failure, or missing endpoint.

### Integration Notes for Specific Upstream and Downstream Layers

Identity Asset Integration: When an upstream identity asset certificate is supplied, the gateway may store its certificate hash and signed receipt pointer, but the gateway need not mint the identity asset. This integration statement is an express boundary: the present application uses the output or interface of that layer to make the credential routing gateway more concrete, but it does not require that layer as a claim limitation unless recited.

Genesis Terminal Integration: When a terminal state is supplied, the gateway may treat draft, review, freeze, revoked, or non-live states as policy gates and may treat live states as eligible subject to context rules. This integration statement is an express boundary: the present application uses the output or interface of that layer to make the credential routing gateway more concrete, but it does not require that layer as a claim limitation unless recited.

Deterministic Proof Integration: When a canonical profile or proof set is supplied, the gateway may use it to serialize TransferKey payloads and make receipts recomputable by third-party verifiers. This integration statement is an express boundary: the present application uses the output or interface of that layer to make the credential routing gateway more concrete, but it does not require that layer as a claim limitation unless recited.

BEISIGN Integration: When a dual-signature protocol is supplied, the gateway may include a primary secure-enclave signature and secondary guardian signature in the evidence envelope. This integration statement is an express boundary: the present application uses the output or interface of that layer to make the credential routing gateway more concrete, but it does not require that layer as a claim limitation unless recited.

Intention Navigation Integration: When an intention vector and temporal trust score are supplied, the gateway may select an access object template and risk threshold accordingly. This integration statement is an express boundary: the present application uses the output or interface of that layer to make the credential routing gateway more concrete, but it does not require that layer as a claim limitation unless recited.

24HWS Layer Integration: When a ReadName, EmotionComm, GeoNode, Time Wallet, Contribution NFT, AI Guardian, local-global bridge, or platform fabric is supplied, the gateway converts it into a RootedDomain credential, access context, receipt, or interface reference. This integration statement is an express boundary: the present application uses the output or interface of that layer to make the credential routing gateway more concrete, but it does not require that layer as a claim limitation unless recited.

Sub-Bank Integration: When a sub-bank endpoint is supplied, the gateway may generate authorization and pass it downstream, but settlement, risk enforcement, compliance execution, and ledger posting remain in the downstream layer. This integration statement is an express boundary: the present application uses the output or interface of that layer to make the credential routing gateway more concrete, but it does not require that layer as a claim limitation unless recited.

### Implementation Pseudocode

Pseudocode step 1: Receive access_request from source terminal or API.
Pseudocode step 2: Resolve source RootedDomain into credential_state, policy_state, route_descriptor, terminal_state, and revocation_reference.
Pseudocode step 3: If credential_state is invalid, expired, frozen, or revoked, write receipt with rejection code and stop.
Pseudocode step 4: Build or receive intention_vector and select context type.
Pseudocode step 5: Retrieve temporal_trust_score and endpoint capability if available.
Pseudocode step 6: Generate nonce and time_window according to context policy.
Pseudocode step 7: Check consumed_nonce_table, revocation state, terminal lifecycle state, policy version, and endpoint compatibility.
Pseudocode step 8: Build canonical_payload with source domain, target endpoint, context type, permission scope, nonce, time window, route digest, credential digest, policy hash, and receipt pointer.
Pseudocode step 9: Compute TransferKey digest and obtain primary signature.
Pseudocode step 10: If risk score exceeds threshold, obtain guardian or secondary signature.
Pseudocode step 11: Derive TransKey for target endpoint and context.
Pseudocode step 12: Generate context-specific access object using the selected template.
Pseudocode step 13: Deliver access object to endpoint or downstream interface.
Pseudocode step 14: Write signed gateway receipt with decision code, reason code, digests, signatures, and proof references.
Pseudocode step 15: Update lifecycle state, consumed nonce table, trust state, and verifier cache as required.

### Additional Industry and Product Deployment Examples

In a hospital patient routing deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The hospital patient routing deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a cross-border family remittance deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The cross-border family remittance deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a school credential issuance deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The school credential issuance deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a eldercare emergency routing deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The eldercare emergency routing deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a legal consent verification deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The legal consent verification deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a warehouse sensor exception deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The warehouse sensor exception deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a smart vehicle command authorization deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The smart vehicle command authorization deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a public-service disaster broadcast deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The public-service disaster broadcast deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a merchant checkout authorization deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The merchant checkout authorization deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a AI agent tool execution deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The AI agent tool execution deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a robotics safety command deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The robotics safety command deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a energy-grid device response deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The energy-grid device response deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a agriculture sensor maintenance deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The agriculture sensor maintenance deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a insurance claim verification deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The insurance claim verification deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a community governance vote routing deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The community governance vote routing deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a domain inheritance and recovery deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The domain inheritance and recovery deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a BEIMINT contribution recording deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The BEIMINT contribution recording deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a BEIIndex update after validated service deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The BEIIndex update after validated service deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a wallet clearing handoff deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The wallet clearing handoff deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

In a SIP/WebRTC communication session deployment, the RootedDomain credential identifies the requesting person, device, institution, wallet, agent, or terminal. The gateway receives context fields appropriate to that deployment, checks policy and trust state, generates a TransferKey and a scoped TransKey, and outputs an access object to the selected endpoint. The signed receipt preserves the credential path, decision reason, proof references, and any downstream interface pointer. This allows a licensee to implement the deployment without rewriting the core gateway architecture.

The SIP/WebRTC communication session deployment can be configured as a product license, SDK license, API license, platform license, endpoint-directory license, evidence-ledger license, or industry-module license. The commercial arrangement is not the claimed invention; the technical gateway path remains the same: RootedDomain credential resolution, context selection, key generation, access-object issuance, receipt storage, and lifecycle control.

### Verifier, Audit, and Due-Diligence Implementations

Verifier endpoint embodiment: A verifier may receives a receipt identifier and returns whether the access object was issued under an active credential, valid policy version, unexpired time window, unconsumed nonce, and non-revoked state. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the verifier endpoint embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Investor diligence package embodiment: A verifier may contains allowed upstream identity asset references, gateway receipts, proof-set pointers, BEISIGN evidence envelopes, endpoint activation records, and downstream interface acknowledgments without exposing raw private behavioral evidence. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the investor diligence package embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Regulated payment review embodiment: A verifier may uses the gateway receipt to show that a payment authorization object was generated by a verified RootedDomain credential, but leaves bank-level KYC, AML, clearing, and settlement to downstream execution systems. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the regulated payment review embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Communication provider verification embodiment: A verifier may check a signaling header reference before accepting a call or message session and can reject the session if the receipt shows revoked credential state or expired TransKey scope. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the communication provider verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Device manufacturer verification embodiment: A verifier may check device attestation, command scope, terminal state, and receipt pointer before allowing a device enrollment, command, maintenance operation, or remote revocation. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the device manufacturer verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Emergency responder verification embodiment: A verifier may accepts a priority access object only if the emergency namespace, route descriptor, time window, credential state, and post-event audit policy are valid. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the emergency responder verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Local community deployment embodiment: A verifier may uses local caches and peer receipts while disconnected and later synchronizes receipt digests with a verifier endpoint when network service returns. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the local community deployment embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Asset exchange verification embodiment: A verifier may check asset gate object integrity and proof-set reference before deciding whether to permit a separate exchange, listing, settlement, or clearing workflow. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the asset exchange verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

AI safety verification embodiment: A verifier may check whether the tool call was generated by an authorized AI agent under a bounded policy scope and whether secondary guardian approval was required and obtained. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the ai safety verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Robotics safety verification embodiment: A verifier may check command class, physical safety rule, controller RootedDomain, route score, human confirmation flag, and rollback instruction before actuation. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the robotics safety verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Privacy auditor verification embodiment: A verifier may verifies limited proof objects and receipt digests while confirming that raw behavioral evidence, medical data, financial details, or private location traces are outside the disclosure scope. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the privacy auditor verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Inheritance reviewer verification embodiment: A verifier may check predecessor reference, successor domain, trigger event, guardian or institutional confirmation, key rotation, and continuity evidence before accepting a transferred credential scope. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the inheritance reviewer verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Recovery reviewer verification embodiment: A verifier may check lost-device report, suspended access objects, key rotation, guardian approval, institutional proof, and continuity receipts before reactivating issuance. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the recovery reviewer verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Policy update verification embodiment: A verifier may check policy version hash, update signature, effective date, affected contexts, and rollback rule before applying new BEIGate decision logic. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the policy update verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Endpoint directory verification embodiment: A verifier may check whether target endpoint references were retrieved from a permitted namespace, directory, peer-receipt directory, institutional registry, or deterministic route descriptor. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the endpoint directory verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Receipt chain verification embodiment: A verifier may check whether the prior receipt hash, current receipt hash, TransferKey digest, TransKey digest, and ledger-state hash are internally consistent. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the receipt chain verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Dispute resolution verification embodiment: A verifier may check signed non-activation evidence, route score, permission basis, denial reason, endpoint status, and privacy scope before reversing, confirming, or marking a route state. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the dispute resolution verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Contribution value verification embodiment: A verifier may check that a value, credit, reward, or index update references a signed contribution event, witness record, route evidence, and user disclosure policy. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the contribution value verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

SDK compliance verification embodiment: A verifier may check that a third-party SDK uses the canonical payload, nonce table, context-specific templates, receipt generation, and revocation propagation rules required for interoperability. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the SDK compliance verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

Cross-border verification embodiment: A verifier may check jurisdictional metadata, language preference, professional qualification, privacy scope, local endpoint capability, and downstream compliance boundary without requiring the gateway to become the jurisdictional decision maker. The verification response may include allow, deny, stale, expired, revoked, disputed, pending-secondary-verification, or insufficient-disclosure status. This embodiment reinforces the machine-verifiable nature of the gateway because each status is derived from recorded credential, key, policy, route, nonce, receipt, and lifecycle state rather than from a post-hoc narrative.

In the cross-border verification embodiment, the gateway can expose an API method such as verifyReceipt, verifyAccessObject, verifyCredentialState, verifyEndpointScope, or verifyRevocation. The names are non-limiting. What matters is that the verifier receives a digest or reference and checks a bounded set of recorded fields so that private data remains protected while authorization integrity remains testable.

### Additional Anti-Design-Around Equivalents

For anti-design-around purposes, the term RootedDomain resolver may be implemented by or mapped to a DHT address mapper, DID resolver, content-addressed name service, private namespace table, institutional registry, route directory, endpoint directory, or deterministic namespace graph, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term TransferKey may be implemented by or mapped to a credential-bound access package, route authorization object, session authority object, context token, proof-bound capability, or gateway pass, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term TransKey may be implemented by or mapped to a derived session key, transaction key, command key, navigation key, device key, wallet key, asset gate key, or one-time endpoint token, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term BEIGate may be implemented by or mapped to an authorization gateway, policy gateway, toll gateway, risk gateway, zero-trust access broker, route gate, or credential pass gate, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term signed gateway receipt may be implemented by or mapped to an evidence envelope, proof receipt, ActionLedger entry, TimeTape snapshot, proof-set leaf, QR verifier record, API log certificate, or structured message evidence reference, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term intention vector may be implemented by or mapped to a context vector, demand vector, service-intent object, task descriptor, route-intent proof, emergency descriptor, AI-agent instruction object, or service request embedding, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term temporal trust routing score may be implemented by or mapped to a risk score, trust score, endpoint score, route score, confidence score, permission fit score, time-decay graph score, or availability-weighted service score, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term device access object may be implemented by or mapped to an IoT command object, robot instruction object, vehicle authorization object, sensor command object, hardware-attested session object, or secure enclave authorization object, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term payment authorization object may be implemented by or mapped to a remittance object, wallet authorization, merchant checkout token, value descriptor object, downstream sub-bank request, or settlement request reference, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

For anti-design-around purposes, the term navigation intent object may be implemented by or mapped to a GeoNode proof, location-intent object, route-intent object, presence proof, movement confidence object, or privacy-limited route object, provided that the implementation preserves the same functional relationship among RootedDomain credential state, context-specific access authorization, replay prevention, policy decision, signature or proof, receipt generation, and lifecycle control. This statement does not expand a claim beyond its language; it clarifies that equivalent engineering names do not defeat the disclosed technical passage.

### CONCLUSION

The disclosed BEI RootedDomain credential routing gateway provides a machine-implemented architecture for converting a resolved RootedDomain credential into a bounded, context-specific access object. In operation, a RootedDomain identifier is resolved into credential state, policy state, route descriptor information, and revocation state; a behavioral credential proof reference or credential verification reference is evaluated; a nonce or replay-prevention value and a time-window value are applied; and a TransferKey or derived TransKey is generated for a requested communication, payment, navigation, device-access, or asset-routing context.

The disclosed gateway is not merely a commercial label, a domain-name naming convention, or a generalized identity assertion. The gateway changes machine state by issuing, denying, revoking, freezing, rolling back, recovering, or routing a bounded access object according to credential state, policy state, replay-prevention state, time-window state, route descriptor information, and revocation state. A signed gateway receipt records the gateway decision and associated proof-reference, policy, route, time-window, revocation, and receipt information so that downstream systems or verifiers can reconstruct the authorization path without requiring exposure of unnecessary private credential material.

The disclosed architecture may interoperate with upstream BEI identity-root, behavioral certification, proof-bundle, endpoint-record, and accounting-receipt systems and with downstream communication, payment, navigation, device, asset-routing, exchange, settlement, audit, rollback, and recovery systems. Such interoperability does not collapse the gateway into an upstream identity issuance system or a downstream settlement system. Rather, the gateway provides a distinct credential-routing and access-object generation layer in which TransferKey generation, derived TransKey operation, context-specific access-object issuance, replay-prevention, time-window enforcement, revocation handling, rollback or recovery propagation, and signed gateway-receipt generation operate together as an ordered technical sequence.

Accordingly, the disclosed embodiments provide a practical computer-network improvement for credential-based routing and access control across heterogeneous service contexts. The scope of the invention is not limited to any particular brand, website, token format, ledger, wallet, communication provider, payment network, navigation provider, device platform, exchange, or settlement system unless expressly recited in a claim. Equivalent machine-resolvable identity-root identifiers, route descriptors, policy containers, credential states, proof references, derived keys, access objects, endpoint records, receipt records, and lifecycle-state controls may be used while preserving the described RootedDomain credential-routing gateway architecture.

What is claimed is:

1. A BEI RootedDomain credential routing gateway system, comprising: a RootedDomain resolver configured to resolve a BEI RootedDomain identifier into a credential state, a policy state, and at least one service route descriptor; a behavioral credential verification engine configured to verify a behaviorally certified identity credential associated with the BEI RootedDomain identifier; a TransferKey or derived TransKey generation module configured to generate a context-specific cryptographic access object for a requested access context, wherein the context-specific cryptographic access object comprises an object identifier, a context type, a source RootedDomain reference, a target endpoint reference, a permission scope, a nonce or replay-prevention value, a time-window value, a revocation reference, a cryptographic signature, and a receipt pointer; a gateway authorization module configured to determine whether the requested access context is authorized based on the credential state, the policy state, the replay-prevention value, and a revocation state; a route execution module configured to output a communication access object, payment authorization object, navigation intent object, device access object, or asset-routing object; and a receipt module configured to generate a signed gateway receipt associated with the resolved BEI RootedDomain identifier and the generated context-specific cryptographic access object.

2. The system of claim 1, wherein the RootedDomain resolver generates a signed resolution descriptor comprising a domain identifier, a credential identifier, a policy identifier, a route endpoint identifier, and a route descriptor digest.

3. The system of claim 1, wherein the behavioral credential verification engine verifies at least one of a time-based behavioral proof, a biometric proof, a device-behavior proof, a transaction-behavior proof, a location-intent proof, a liveness proof, or a cryptographic commitment to such proof.

4. The system of claim 1, wherein the TransferKey or derived TransKey generation module generates a short-lived transaction key bound to a time window, a nonce, a request context, a permission scope, a route descriptor digest, and a BEI RootedDomain credential.

5. The system of claim 1 wherein the gateway authorization module applies a toll rule fee rule routing rule, compliance rule, risk-control rule, temporal trust routing score, or privacy rule before allowing the route execution module to output the context-specific cryptographic access object.

6. The system of claim 1, wherein the signed gateway receipt comprises an identity header, a route header, a time-window header, a policy header, a verification result, a result code, a cryptographic signature, and an evidence-envelope reference.

7. The system of claim 1, wherein the revocation state causes the gateway authorization module to reject, throttle, freeze, reroute, quarantine, or rollback the requested access context.

8. A computer-implemented method for transforming a BEI RootedDomain identity credential into a context-specific routing access object, comprising: receiving, by a gateway computing system, an access request associated with a BEI RootedDomain identifier: resolving the BEI RootedDomain identifier into a credential state, a policy state, and a route descriptor; verifying a behaviorally certified identity credential associated with the BEI RootedDomain identifier; generating a replay-prevention value and a time-limited TransferKey or derived TransKey bound to a nonce, a time window, a context type, a permission scope, a revocation reference, and a route descriptor digest; selecting an access context from a communication context, a payment context, a navigation context, a device-access context, or an asset-routing context; generating a context-specific cryptographic access object based on the selected access context: outputting the context-specific cryptographic access object to an access endpoint; and recording a signed gateway receipt in association with the BEI RootedDomain identifier and the context-specific cryptographic access object.

9. The method of claim 8, wherein the communication context causes the gateway computing system to generate a communication session access object for routing a message, voice session, video session, callback, SIM-free domain-based call, or asynchronous communication record.

10. The method of claim 8, wherein the payment context causes the gateway computing system to generate a payment or remittance authorization object bound to a payer RootedDomain, a merchant or recipient RootedDomain, a payment amount or value descriptor, a time window, and a signed receipt.

11. The method of claim 8, wherein the navigation context causes the gateway computing system to generate a navigation intent object bound to a route request, a location-intent proof, a privacy rule, a disclosure scope, and a BEI RootedDomain credential.

12. The method of claim 8, wherein the device-access context causes the gateway computing system to generate a device access object for enrolling, binding, authenticating, limiting, delegating, or revoking access to a device without requiring a SIM card identifier as a primary identity root.

13. The method of claim 8, wherein the asset-routing context causes the gateway computing system to generate an asset gate object for accessing or requesting access to a digital asset, credential ledger, sub-bank contract interface, exchange endpoint, deterministic clearing kernel, or settlement endpoint.

14. The method of claim 8, further comprising applying a toll, gateway fee, routing fee, verification fee, risk pre-check, or settlement-interface fee before outputting the context-specific cryptographic access object.

15. The method of claim 8, further comprising detecting an anomaly in the access request and, in response, generating a freeze instruction, rollback instruction, revocation update, quarantine route, denial receipt, or recovery-only state.

16. A non-transitory computer-readable medium storing instructions that, when executed by one or more processors, cause a BEI gateway computing system to: resolve a BEI RootedDomain identifier into a credential state, policy state, and route descriptor: verify a behaviorally certified identity credential; generate a TransferKey or derived TransKey bound to a time window, nonce, access context, permission scope, route descriptor digest, and revocation state; generate a context-specific access object for communication, payment, navigation, device access, or asset routing; apply a gateway rule for authorization, tolling, compliance, risk control, temporal trust scoring, privacy control, or revocation; and store a signed gateway receipt associated with the context-specific access object.

17. The non-transitory computer-readable medium of claim 16, wherein the instructions cause the BEI gateway computing system to expose an application programming interface for generating or verifying derived TransKeys for third-party merchants, devices, wallets, communication systems financial gateways emergency systems artificial-intelligence agents or exchange endpoints.

18. The non-transitory computer-readable medium of claim 16, wherein the instructions cause the BEI gateway computing system to synchronize revocation, renewal, inheritance, delegation, terminal-state, policy-container, freeze, rollback, or recovery states associated with the BEI RootedDomain identifier.

19. The non-transitory computer-readable medium of claim 16, wherein the instructions cause the BEI gateway computing system to generate an audit package comprising the signed gateway receipt, the route descriptor, the credential verification result, the policy decision record, a TransferKey digest, a TransKey digest, and a proof-set or evidence-envelope reference.

20. The non-transitory computer-readable medium of claim 16, wherein the instructions cause the BI gateway computing system to interface with at least one of a domain routing layer, a BEI identity asset layer, an identity terminal layer, an intention navigation layer, a deterministic proof layer, a sub-bank computing system, a communication system, a payment system, a navigation system, a device-access system, or a digital asset exchange system.
